(19) United States
(12) Patent Application Publication
(10) Pub. No.: US 2024/0152848 A1
(43) Pub. Date: May 9, 2024

(54) SYSTEMS, METHODS, AND MEDIA FOR MANAGING EDUCATION PROCESSES IN A DISTRIBUTED EDUCATION ENVIRONMENT

(71) Applicant: Brandeis University, Waltham, MA (US)

(72) Inventors: Benjamin Gomes-Casseres, Waltham, MA (US); R. Pito Salas, Waltham, MA (US); Klodeta Janaqi, Waltham, MA (US)

(21) Appl. No.: 18/549,945

(22) PCT Filed: Mar. 11, 2022
(86) PCT No.: PCT/US2022/020025

§ 371 Date: Sep. 11, 2023

Related U.S. Application Data
(60) Provisional application No. 63/159,604, filed on Mar. 11, 2021.

(51) Int. Cl. G06Q 10/0639; G06Q 50/20; G09B 5/14

(52) U.S. Cl. CPC G06Q 10/06395; G06Q 50/205; G09B 5/14

(57) ABSTRACT

In accordance with some embodiments, systems, methods, and media for managing education processes in a distributed education environment are provided. In some embodiments, a system comprises at least one processor programmed to: receive information from multiple sources about a live educational process being experienced in a distributed education environment that facilitates real-time communication between an educator and students including at least audio communications; extract educational effectiveness indicators from at least the audio communications and an operation of the distributed education environment during the live educational process, including at least one of a number of audio communications, length of audio communications, or number of audio interactions by each student; access a database of demographic information about the students and correlate the demographic information with the students; and generate reports about individual students and groups within the students using the one or more educational effectiveness indicators and the demographic information.

### CROSS-REFERENCE TO RELATED APPLICATIONS

This application is based on, claims the benefit of, and claims priority to U.S. Provisional Patent Application No. 63/159,604, filed Mar. 11, 2021, which is hereby incorporated herein by reference in its entirety for all purposes.

### STATEMENT REGARDING FEDERALLY SPONSORED RESEARCH

N/A

### BACKGROUND

As networking technologies have matured, online learning has become an increasingly prevalent and utilized option. The rate of adoption of online learning has recently accelerated as schools and other organizations reduced in-person interactions during the COVID-19 pandemic.

In a distributed education environment, monitoring, encouraging, and evaluating the participation and class performance of students can be more challenging as compared to traditional in-person education. The visibility that instructors have on the overall conduct and progress of their course is also different between these settings. The pedagogical goals of such activities in virtual and traditional discussion classes are generally the same, as is the material taught. Personal interaction traditionally allows instructors to try to ensure for equity in participation, give accurate feedback to students about their participation, and measure the instructor's own performance and pedagogical designs. Students learn by interacting with each other, and their grades often depend on their rate and quality of their participation in class discussions.

In an online learning environment, an instructor's ability to engage and observe students is often limited to only a current speaker or a small group of students. Screen space constrains the number of students that the instructor can observe at one time. Relatively subtle cues that an instructor can rely on to judge whether students are engaged in the discussion (e.g., based on body language of students) are difficult or impossible to reliably observe in a virtual learning environment. Students, on their part, may find it more difficult to participate effectively in the online class, even if their grade still depends on such participation.

Accordingly, new systems, methods, and media for managing education processes in a distributed education environment are desirable.

### SUMMARY

In accordance with some embodiments of the disclosed subject matter, systems, methods, and media for managing education processes in a distributed education environment are provided.

In accordance with some embodiments of the disclosed subject matter, a system for managing education processes in a distributed education environment is provided, the system comprising: a computer system including at least one processor programmed to: receive information from a plurality of sources about a live educational process being experienced in a distributed education environment where at least an educator is remotely located from one or more students and the distributed education environment facilitates real-time communication between the educator and the one or more students including at least audio communications; extract one or more educational effectiveness indicators from at least the audio communications and an operation of the distributed education environment during the live educational process, wherein the one or more educational effectiveness indicators include at least one of a number of audio communications by each of the one or more students during the live educational process, a number of audio communications by an educator during the live educational process, length of audio communications by each of the one or more students during the live educational process, timing of audio communications by each of the one or more students during the live educational process, number of audio interactions by each of the one or more students during the live educational process, and number of audio interactions by the educator during the live educational process; access at least one database of demographic information about the one or more students and correlate the demographic information with the one or more students; and generate a plurality of reports about individual students of the one or more students and groups within the one or more students using the one or more educational effectiveness indicators and the demographic information.

In some embodiments, the at least one processor is further programmed to: receive information from the plurality of sources about a plurality of live educational processes being experienced in the distributed education environment; and aggregate one or more educational effectiveness indicators and the plurality of reports across the plurality of live educational processes.

In some embodiments, the at least one processor is further programmed to: extract the one or more educational effectiveness indicators from a number of video communications that accompany the audio communications.

In some embodiments, the at least one processor is further programmed to: receive information from the plurality of sources about a plurality of live educational processes across an educational institution being experienced in the distributed education environment; and aggregating one or more educational effectiveness indicators and the plurality of reports across the plurality of live educational processes.

In some embodiments, the at least one database of demographic information includes a registration database of the educational institution.

In some embodiments, the at least one database of demographic information includes a registration database of part of the educational institution.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for managing education processes in a distributed education environment in accordance with some embodiments of the disclosed subject matter.

FIG. 2 shows an example of hardware that can be used to implement a computing device, and a server, shown in FIG. 1 in accordance with some embodiments of the disclosed subject matter.

FIG. 3 shows an example of a process for managing education processes in a distributed education environment in accordance with some embodiments of the disclosed subject matter.

FIG. 4 shows an example 400 of a flow for managing education processes in a distributed education environment in accordance with some embodiments of the disclosed subject matter.

FIGS. 5A and 5B show an example of at least a portion of a report generated using the mechanisms described herein illustrating the average shares of multiple classes of participants in the course, and the parts of each class that were recorded and analyzed.

FIG. 6 shows an example of a report generated using mechanisms described herein illustrating total participation across classes by students, an instructor, and other participants.

FIGS. 7A to 7C show examples of at least portions of reports generated using mechanisms described herein illustrating participation by female and male students across classes in a course.

FIGS. 8A to 8C show examples of at least portions of reports generated using mechanisms described herein illustrating participation by English-as-a-first language students and English-as-a-second-language students across classes in a course.

FIGS. 9A and 9B show an example of at least a portion of a report generated using mechanisms described herein illustrating participation by students in different degree programs across classes in a course.

FIG. 10 shows an example of a report generated using mechanisms described herein illustrating the average speech times of students in a given class.

FIGS. 11A and 11B show an example of a report generated using mechanisms described herein illustrating participation by a particular student, with name encoded here, across classes in a course, in comparison to average performance of other students with the same demographic characteristics as the particular student, and an example of a report showing the particular student's performance in multiple courses during the year.

FIG. 12 shows an example of a report generated using mechanisms described herein illustrating participation by each students in each class by two measures.

FIG. 13 shows an example of a report generated using mechanisms described herein illustrating a particular student's participation in a given class and reporting a transcription of what the student said.

FIG. 14 shows an example of at least a portion of a report generated using mechanisms described herein illustrating speech time of an instructor and students over the course of a class.

FIG. 15 shows an example of at least a portion of a report generated using mechanisms described herein illustrating conversation switches and number of participants in a discussion over the course of a class.

FIG. 16 shows an example of at least a portion of a report generated using mechanisms described herein illustrating a rate of speech of an instructor and students over the course of a class.

FIG. 17 shows an example of at least a portion of a report generated using mechanisms described herein illustrating speech time by each of various students over the course of a class.

FIG. 18 shows an example of at least a portion of a report generated using mechanisms described herein illustrating average speech time by gender.

FIG. 19 shows an example of at least a portion of a report generated using mechanisms described herein illustrating average speech time by English as a second language status.

FIG. 20 shows an example of at least a portion of a report generated using mechanisms described herein illustrating participation by each of various students over the course of a series of classes by total time and instances of speech.

FIG. 21A shows an example of at least a portion of a report generated using mechanisms described herein illustrating participation by various demographic groups in various courses.

FIG. 21B shows an example of at least a portion of a report generated using mechanisms described herein illustrating portions of class time associated with various types of activity in various courses.

### DETAILED DESCRIPTION

In accordance with various embodiments, mechanisms (which can, for example, include systems, methods, and media) for managing education processes in a distributed education environment are provided.

While the COVID-19 pandemic has increased the rate of adoption of online learning technologies, advancements in such technologies will remain useful after the pandemic. For example, such technologies can be expected to improve the learning experience of students in a distributed educational environment, which may accelerate long-term trends toward more online education. Mechanisms described herein can provide tools to manage educational processes in distributed educational environments.

In some embodiments, mechanisms described herein can facilitate analysis of engagement by participants in an interactive remote meeting environment, such as a distributed educational environment. For example, as described below, mechanisms described herein can use indicators of engagement extracted from user-generated media content representing real-time communication between participants in an interactive remote meeting environment to evaluate the engagement of various participants in the remote meeting. In some embodiments, mechanisms described herein can utilize data related to participation by various participants to generate new and more accurate metrics for evaluating engagement in an interactive remote meeting environment.

Unlike most in-person meetings (e.g., classes, seminars, workshops, brainstorming sessions, pitches, etc.), virtual meetings can facilitate measurement of activity that is not practical in conventional settings. For example, technology used in online learning can facilitate quantification of activity at a granularity that is not possible for an instructor leading a class. In such an example, a platform used to facilitate an online class can record who was present (e.g., based on a username, based on a phone number used to call in, etc.), and can identify when each participant speaks (e.g., by determining when audio corresponding to speech is received from a particular user device). Mechanisms described herein can assist instructors, students, administration, and/or any other suitable parties in evaluating effectiveness of a particular discussion (e.g., a particular class), a particular course, a set of courses in a school, a particular instructor, etc. Mechanisms described herein can also help in ensuring that the online processes are engaging and accessible for all students.

In some embodiments, mechanisms described herein can improving online learning experiences by facilitating evaluation of one or more participant's engagement throughout the educational process. For example, mechanisms described herein can analyze data indicative of engagement to automatically (e.g., without substantial user input) generate useful output and feedback to assist instructors engagement with students, evaluation of student performance, and feedback to students on their in-class performance. As another example, automatic analysis of a live educational process can facilitate evaluation of a pattern of class participation for individual students, groups of students that share one or more common characteristics, etc.

In some embodiments, mechanisms described herein can extract data from digital recordings of an online meeting (e.g., video, text, other records from online meetings, etc.), and use the data to analyze how participants in the meeting related to each other during the meeting. For example, the pattern of engagement in the meeting of individuals and categories of individuals can be analyzed. Such patterns of engagement can be used by meeting participants and/or organizers to improve products, services, and/or personal development.

In some embodiments, mechanisms described herein can use information from a transcript of a meeting to analyze behavior of participants (e.g., students, instructors, organizers, employees, etc.). For example, a technology platform used to facilitate the meeting (e.g., via video conferencing, via audio conferencing, etc.) can generate a transcript indicative of when each participant spoke and/or what each participant said (e.g., via a transcript). As another example, a technology platform used to facilitate the meeting can generate a record of when each participant was speaking even if the platform did not record what each participant said via a transcript.

In some embodiments, mechanisms described herein can use data indicative of participation (e.g. when each participant in a meeting spoke and for how long) to determine data related to engagement (e.g., how many times each participant engaged, speaking time, total words spoken, and/or any other suitable data). In some embodiments, data indicative of participation can be used to analyze participation in the meeting to generate various metrics indicative of engagement. For example, mechanisms described herein can analyze data indicative of participation to calculate a rate of participation by participants in particular categories. In a more particular example, mechanisms described herein can analyze data indicative of participation to calculate a rate of participation by male and female participants in a class. As another more particular example, mechanisms described herein can analyze data indicative of participation to calculate a rate of participation by native English speakers and students with English as a second language in each class. As yet another more particular example, mechanisms described herein can analyze data indicative of participation to calculate a rate of participation by students with different educational backgrounds (e.g., students in different degree programs, students in departments, undergraduate students and graduate students, etc.). In such examples, mechanisms described herein generate one or more reports illustrating rates of participation.

As still another more particular example, mechanisms described herein can analyze data indicative of participation to generate a report with an overview or participation, and time distribution of participation by students, instructor, speakers, presenters, etc.

In some embodiments, mechanisms described herein can be used in a variety of applications. For example, mechanisms described herein can be used to monitor class participation in an live educational process experienced in a distributed environment at any level of education (e.g., undergraduate, graduate, post-graduate, secondary, elementary, etc.). As another example, mechanisms described herein can be used to provide feedback to an instructor and/or student to facilitate improve effectiveness of the instructor and/or student. As another example, mechanisms described herein can be used to provide an instructor with detailed measurements that can be used in grading participation. In a more particular example, mechanisms described herein can help an instructor provide accurate and granular feedback to students about their in-class performance. As still another example, mechanisms described herein can be used to provide feedback indicative of audience engagement in a business pitch.

In some embodiments, mechanisms described herein can receive data as one or more input files that can be used to analyze engagement. For example, mechanisms described herein can receive one or more files from a videoconferencing platform. As another example, mechanisms described herein can receive one or more files including demographic information. As yet another example, mechanisms described herein can receive one or more files including information that can be used to correlate information received from a video conferencing platform with demographic information.

In some embodiments, mechanisms described herein can generate results formatted as one or more output files that can be used to evaluate participation and/or educational effectiveness. For example, mechanisms described herein can generate one or more reports, one or more dashboards, etc., that can be presented to a participant (e.g., a student, an instructor, a presenter, an audience member, etc.) to provide insight into engagement in one or more meetings. A class meeting (e.g., a lecture, a discussion section, a lab, etc.) can represent an example of a live educational process that can be managed using mechanisms described herein. Such a live educational process can be experienced in a distributed educational environment if at least some of the participants are participating remotely via a communication device (e.g., a computing device executing a communication platform application, a telephone). As another example, mechanisms described herein can generate one or more reports, one or more dashboards, etc., that can be presented to a non-participant (e.g., an administrator, a supervisor, a consultant, etc.) to provide insight into engagement in one or more meetings.

In some embodiments, mechanisms described herein can calculate a participant's speech time (e.g., measured in seconds) that reflects the amount of time that a particular participant spoke during a particular period. For example, mechanisms described herein can calculate speech time in a particular meeting, such as a single meeting of a class. As another example, mechanisms described herein can calculate a participant's speech time in a series of meetings, such as a series of classes that are included in a course. As still another example, mechanisms described herein can calculate a participant's speech time in a set of meetings that may or may not be related, such as all classes in a particular department, all classes at a particular university, etc. In some embodiments, a participant's speech time can be a primary unit of measurement in analyses and outputs generated using mechanisms described herein.

In some embodiments, mechanisms described herein can count how many times each participant speaks. For example, a speech instance can be recorded when a person speaks for more than a predetermined amount of time (e.g., 5 seconds, 10 seconds, 15 seconds, etc.) in a block of time that is separated from other speech instances by that person by more than a predetermined amount of time (e.g., 60 seconds, 90 seconds, 120 seconds, or any other amount of time that measure gaps between instances of speech). For example, if a person speaks twice for a total of 30 seconds in a span of 150 seconds, mechanisms described herein can record total speech time, number of instances, and other measurements of the pattern of participation. Note that each time the person spoke may not be recorded as a speech instance (e.g., if the amount of time is less than the threshold). A visual representation of speech instances over time can reflect how involved each student is during the time of the class, and can be used to analyze who interacts with whom in the class conversation. In some embodiments, speech instances can be a secondary unit of measurement in analyses and outputs generated using mechanisms described herein.

Measurements of speech time and speech instances described herein can be performed in a distributed educational environment at a level of accuracy, granularity, and variety that is not possible in traditional in-person class discussions. Such accuracy, granularity, and variety of measurements can facilitate complex feedback to students and/or instructors that is not available in in-person educational processes. Such measures and accurate feedback can be used by an instructor and/or students to learn about, and improve, their behavior, in a manner not available in traditional classes in which the corresponding evaluations are often based on personal impressions and memory, and sometimes supplemented by comparatively rudimentary notes taken by an instructor or a teaching assistant (e.g., documenting that a student participated in a particular class, or contributed an insightful comment). The evaluations made by different instructors or teaching assistants in traditional classes, based on impressions and memory, will vary according to the evaluation scales and criteria used by each instructor or teaching assistant. Because of this variability, it can be impossible to derive reliable statistical conclusions, which are useful in managing the educational process. As an example, when a student is evaluated according to different criteria and scales by different instructors or teaching assistants, it can be impossible to understand the student's overall performance or the student's performance changes over time during a program of study (if the evaluations are at different times).

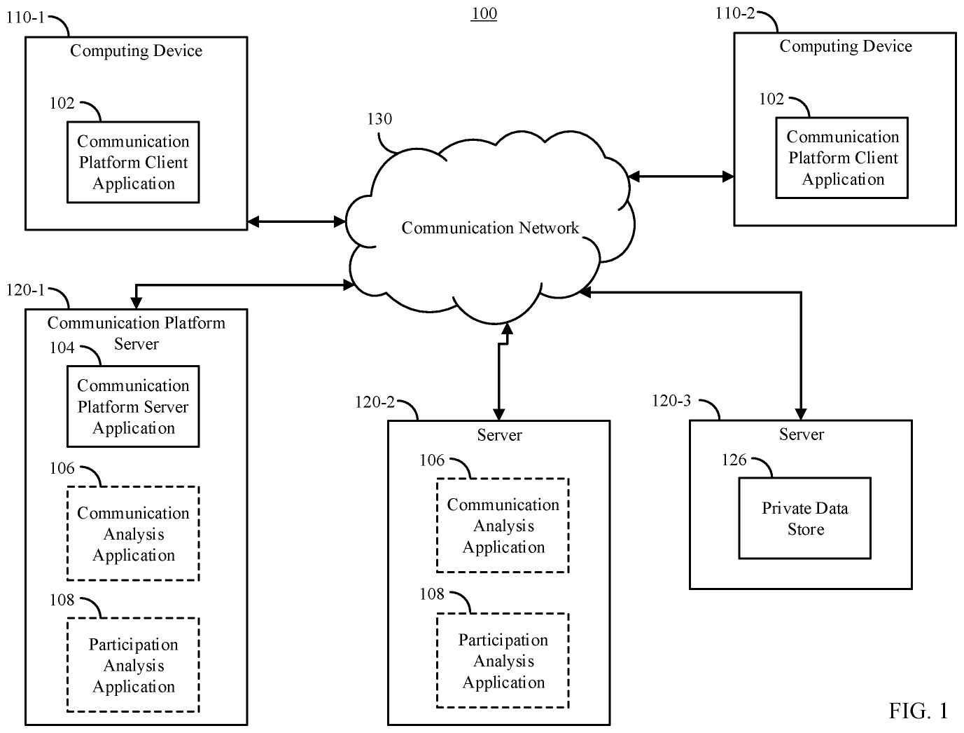

FIG. 1 shows an example 100 of a system for managing education processes in a distributed education environment in accordance with some embodiments of the disclosed subject matter. As shown in FIG. 1, in some embodiments, system 100 can include multiple computing devices 110 that can execute a communication platform client application 102 that can transmit and/or receive communications, such as audio, video, text, images, etc. In some embodiments, computing device 110 can execute communication platform client application 102 to capture video of a user of computing device 110 (e.g., using a digital camera), capture audio of a user of computing device 110 (e.g., using a microphone), transmit audio and/or video to one or more other computing devices (e.g., via a server executing a communication platform server application 104), receive audio and/or video captured by other computing devices 110 (e.g., via a server executing a communication platform server application 104), cause the received audio and/or video to be presented (e.g., using a display device). In some embodiments, communication platform client application 102 can be installed in memory of computing device 110. Alternatively, in some embodiments, communication platform client application 102 can be executed within a web browser or other suitable application.

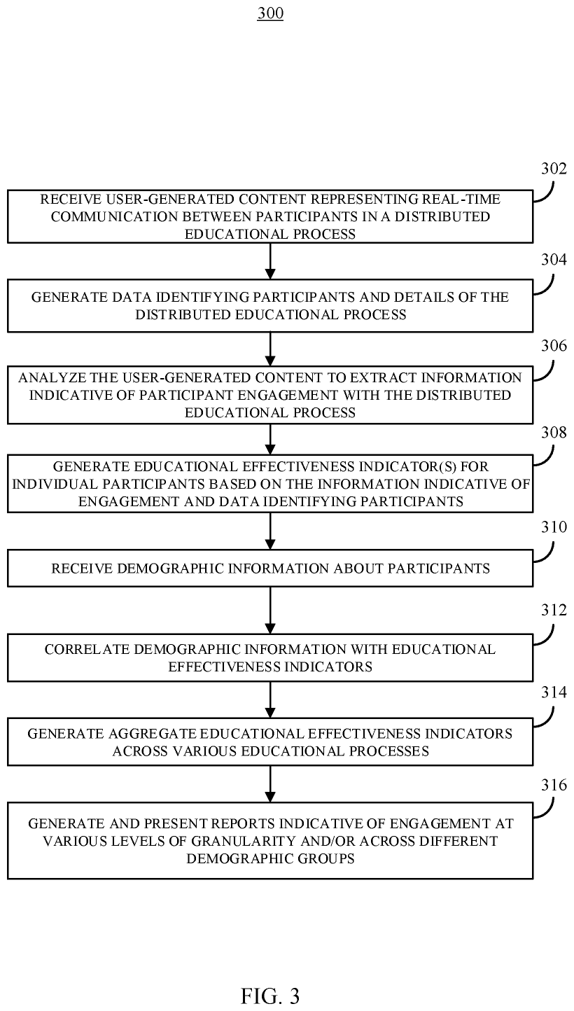

In some embodiments, a server 120-1 that is associated with a communication platform can execute a communication platform server application 104 that can facilitate communications (e.g., of audio, video, text, images, etc.) between computing devices 110 executing client applications. In some embodiments, each computing device 110 participating in a meeting can transmit audio and/or video to server 120-1, and server 120-1 can transmit audio and/or video received from multiple computing devices to other computing devices 110 participating in the meeting. In some embodiments, communication platform server application 104 can maintain data related to users that participated in a meeting, when users joined a meeting, when users left a meeting, whether and/or when the user's audio was muted, etc. In some embodiments, communication platform server application 104 can execute one or more portions of process 300 described below in connection with FIG. 3 (e.g., receiving content at 302, generating data identifying users that participated in a meeting and/or other information related to a meeting at 304). In some embodiments, audio can be communicated to 120-1 from a computing device (e.g., computing device 110) can be associated with a particular user (e.g., a user logged in to the communication platform using the computing device). For example, server 120-1 can generate a separate record of audio received from each device, and can associate the audio received from the particular device from which the audio was received. In some embodiments, server 120-1 (e.g., via communication platform server application 104) can generate data that can be used to analyze participation from audio and/or video received from various computing devices 110 (and/or any other suitable devices, such as telephones, as described below) participating in the meeting. For example, server 120-1 can associate audio and/or video received from participating devices with timing information indicative of a time at which the audio and/or video was generated (e.g., audio and/or video can be associated with a time stamp indicating a time at which the audio and/or video was received, a time at which the audio and/or video was transmitted to other devices, etc.). In a more particular example, server 120-1 can index audio and/or video received from a particular device based on a system time of server 120-1 (e.g., which may or may not be synchronized with one or more external time sources, such as an authoritative time server in some embodiments).

Although not shown, in some embodiments, audio can be communicated to 120-1 from a source that is not executing communication platform client application 102. For example, in some embodiments, a user can use a telephone to dial-in to a meeting, and the telephone can communicate audio signals to server 120-1. In some embodiments, such audio can be associated with a particular user who may or may not be participating in the meeting via video using a different device (e.g., via communication platform client application 102 installed on a computing device 110. For example, each user can be associated with a unique identifying information (e.g., not associated with another user participating in the same meeting) that can be used to correlate audio received via telephone with a particular user. In a more particular example, if a user requested (e.g., via communication platform client application 102) that communication platform server application 104 call the user at a specific telephone number. In such an example, audio associated with that telephone number can be associated with the user that requested the call. As another more particular example, each user can be provided with a participant code (e.g., a string of numbers) that can be used when dialing in via telephone, and the user can be prompted to enter a participant code using the telephone in order to be connected to the meeting. In such an example, audio associated with the telephone number that provided a particular participant code can be associated with the user assigned the participant code. As yet another more particular example, each user can be provided with a unique dial-in number. In such an example, when a call is received at that dial-in number, audio signals received on a connection established using the dial-in number can be associated with the user assigned the dial-in number.

In some embodiments, server 120-1 can execute a communication analysis application 106 that can analyze audio and/or video received from various computing devices 110 (and/or other devices) and generate metadata associated with a meeting. As described above, audio data and/or video data received from a particular device(s) can be recorded, and can be used to determine when particular users participated (e.g., by speaking). For example, server 120-1 can analyze audio data and/or video data received from different devices (e.g., computing devices 110, and/or any other suitable devices, such as telephones) to generate a transcript of the meeting (e.g., including times and identifying information of participants in the meeting). In such an example, server 120-1 can associate identifying information associated with a particular computing device 110 with received audio, such as by associating a username of a user that is logged in to a computing device 110 with text in the transcript. As another example, server 120-1 can analyze video data (and/or the absence of video data) received from a device (e.g., computing device 110) to identify indicators of engagement, such as whether a participant's camera was on or off, and whether the participant was looking toward the camera or away from the camera. In some embodiments, communication analysis application 106 can accurately attribute speech or other activity with a particular user by using audio and/or video received from a particular device associated with the user to generate a portion of a transcript. For example, communication analysis application 106 can analyze audio received from each device to generate a transcript for a user associated with that device. In such an example, communication analysis application 106 can generate a transcript for a meeting based on transcripts associated with each user.

In some embodiments, communication analysis application 106 can execute one or more portions of process 300 described below in connection with FIG. 3 (e.g., analyzing content to extract information indicative of user engagement at 306).

In some embodiments, server 120-1 can execute a participation analysis application 108 that can utilize data generated by communication platform server application 104 and/or communication analysis application 106 to generate one or more education effectiveness indicators, to associate one or more education effectiveness indicators with particular users, to generate aggregate educational effectiveness indicators.

In some embodiments, participation analysis application 108 can cause server 120-1 to request demographic information associated with users that participate in a meeting. As described below, such demographic information can be used to generate aggregated education effectiveness indicators for various groups of participants that share one or more demographic characteristics. In some embodiments, server 120-1 to request demographic information from any suitable source. For example, server 120-1 can request demographic information from a server 120-3 that stores demographic information for people associated with a particular organization or institution (e.g., a university) in a private data store 126. In some embodiments, demographic data received from server 120-3 can be at least partially encrypted. For example, names of particular people can be encrypted such that participation analysis application 108 cannot access unnecessary personally identifying information associated with participants. In some embodiments, private data store 126 can be organized into any suitable data structure. For example, private data store 126 can be organized as a database (e.g., a relational database, a non-relational database). In a more particular example, private data store 126 can be organized as a database for multi-variate analysis of data across courses, students, and/or instructors. As another example, private data store 126 can be accessible to instructors, students, and/or administrators on a selective basis. In a more particular example, students can be permitted to access their own data and/or aggregated data (e.g., for courses in which a student is enrolled), and can be inhibited from accessing data about other individual students (e.g., personally identifiable data). As another more particular example, instructors can be permitted to access data for their own courses, and can be inhibited from accessing data about other courses. In some embodiments, private data store 126 can be linked with a distributed education platform (e.g., a platform used to share assignments and feedback) used by an educational institution. In some embodiments, private data store 126 can be a registration or enrollments database of an educational institution or a department thereof.

In some embodiments, participation analysis application 108 can execute one or more portions of process 300 described below in connection with FIG. 3 (e.g., generating educational effectiveness indicators for individuals at 308, access demographic information about participants at 310, correlating demographic information with educational effectiveness indicators at 312, generate aggregated educational effectiveness indicators at 314, and generate reports indicative of engagement.).

Additionally or alternatively, in some embodiments, a server 120-2 can execute communication analysis application 106 and/or participation analysis application 108. In such embodiments, server 120-1 can communicate data used by communication analysis application 106 and/or participation analysis application 108 (e.g., audio data associated with one or more individual users, video data associated with one or more individual users, transcript data, etc.) to server 120-2. For example, server 120-2 can request such information via an application program interface (API). In such embodiments, communication analysis application 106 and/or participation analysis application 108 may be omitted from server 120-1. For example, server 120-2 can request transcript data from an API associated with server 120-1, and can use such transcript data to perform participation analysis using participation analysis application 108. In some embodiments, data used by communication analysis application 106 and/or participation analysis application 108 can be encrypted (e.g., by server 120-1) prior to the data being communicated to server 120-2. In some embodiments, server 120-1 can execute a communication analysis application (e.g., a first instance or first implementation of communication analysis application 106) to analyze audio and/or video received from various computing devices 110 and generate metadata associated with a meeting, and server 120-2 can execute another communication analysis application (e.g., a second instance or second implementation of communication analysis application 106) to generate additional data and/or metadata. Note that communication analysis application 106 implemented by server 120-2 can be an instance of the same communication analysis application that is executed by server 120-1, or can be an instance of a different application. For example, a communication analysis application executed by server 120-1 can analyze audio associated with a meeting to generate a transcript of the meeting in which words spoken during the meeting are associated with particular participants, and a time stamp identifies the times of when those words were spoken, and a communication analysis application executed by server 120-2 can analyze the transcript and can identify speech instances attributable to a particular participant.

Although not shown, in some embodiments, a particular computing device (e.g., a computing device 110-2, which may be associated with a meeting organizer, an instructor, an administrator, etc.) can execute participation analysis application 108. In such embodiments, a server (e.g., server 120-1, server 120-2) can communicate data used by participation analysis application 108 to computing device 110-2. For example, server 120-2 can request such information via an application program interface (API). In such embodiments, communication analysis application 106 and/or participation analysis application 108 may be omitted from server 120-1. In some embodiments, data used by communication analysis application 106 and/or participation analysis application 108 can be encrypted (e.g., by server 120-1) prior to the data being communicated to server 120-2.

In some embodiments, server 120-3 can use private data store 126 to store demographic details associated with an organization and/or institution that exercises control over server 120-3. For example, in some embodiments, server 120-3 can be a server controller by a university, a school district, a business, etc. In some embodiments, server 120-3 can communication at least a portion of demographic details associated with one or more people in response to authorized requests for demographic information from a server executing participation analysis application 108.

In some embodiments, communication network 130 can be any suitable communication network or combination of communication networks. For example, communication network 130 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 130 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In some embodiments, computing devices 110 and/or servers 120 can be any suitable computing device or combination of devices, such as a desktop computer, a laptop computer, a smartphone, a tablet computer, a wearable computer, a server computer, a virtual machine being executed by a physical computing device, etc.

In some embodiments, system 100 can include a device configured to record audio, video, and/or other signals in an environment that includes multiple participants (e.g., multiple students, one or more instructors and one or more students, etc.). In some embodiments, signals recorded by such a device can be provided to communication platform server application 104, communication analysis application 106, and/or participation analysis application 108. In some embodiments, a computing device 110 can be configured to record such signals, and can provide the signals to communication platform server application 104, communication analysis application 106, and/or participation analysis application 108. For example, one or more microphones associated with a computing device (e.g., computing device 110-2) can be used to record audio associated with a particular participant (e.g., an instructor), and one or more microphones (e.g., different microphones) associated with the computing device can be used to record audio associated with multiple participants in a space (e.g., all participants, participants in a particular direction, etc.). Additionally or alternatively, a device (not shown) that is not configured to execute communication platform client application 102 can be used to record signals (e.g., audio, video, etc.) in a space, and such signals can be provided to communication platform server application 104, communication analysis application 106, and/or participation analysis application 108 using any suitable technique or combination of techniques. In some embodiments, recording signals in a shared environment can facilitate analysis of participation by participants that are participating in-person and/or analysis of differences in participation between participants that are participating in-person and those that are participating remotely.

In some embodiments, signals recorded in a shared space (e.g., where it may be difficult to specifically identify a particular participant) can be integrated with signals recorded from remote users that can be more easily attributed to a particular participant. For example, the signals from the shared space can be timestamped and synchronized with the signals from remote users, and can be used to generate a transcript that includes speech from remote participants and participants in a shared space. In such embodiments, information about participation by remote participants and participants in a shared space(s) can be used to analyze hybrid meetings, and can be used to illustrate a balance between remote participants and in-person participants. Meetings that include multiple in-person participants and remote participants can be referred to as hybrid meetings, hybrid classes, etc.

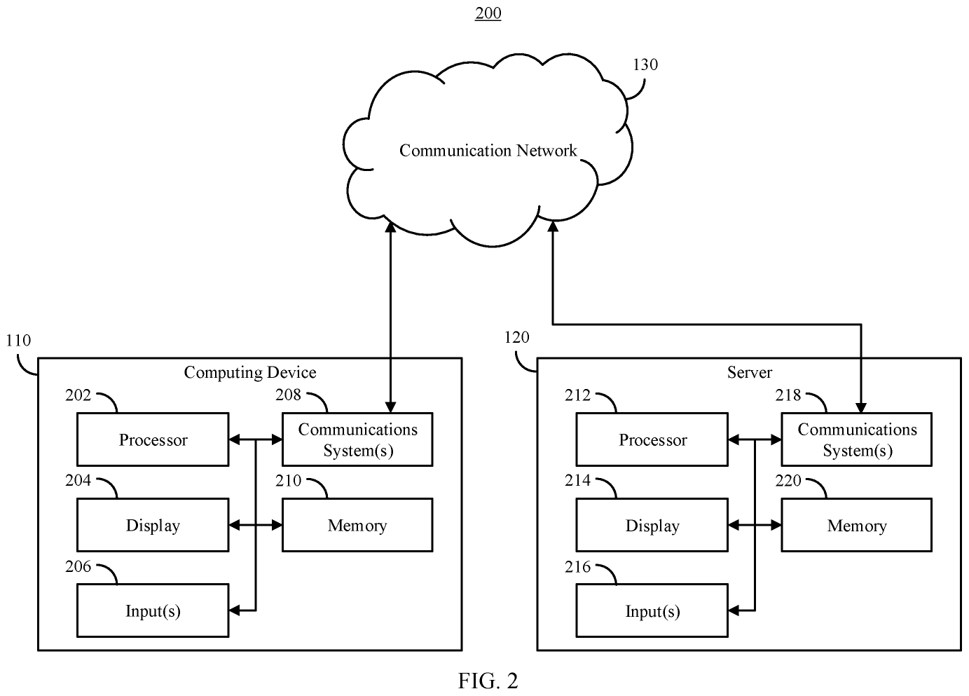

FIG. 2 shows an example 200 of hardware that can be used to implement one or more computing devices 110 and/or servers 120 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, display 204 can include any suitable display devices and/or output devices, such as a computer monitor, a touchscreen, a printing device, a television, a speaker(s), etc. In some embodiments, inputs 206 can include any suitable input devices and/or sensors that can be used to receive user input, such as a keyboard, a mouse, a touchscreen, a microphone, a camera, a wearable electronic sensor, etc.

In some embodiments, communications systems 208 can include any suitable hardware, firmware, and/or software for communicating information over communication network 130 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to present content using display 204, to communicate with server 120 via communications system(s) 208, etc. Memory 210 can include any suitable volatile memory, non-volatile memory, storage, or any suitable combination thereof. For example, memory 210 can include RAM, ROM, EEPROM, one or more flash drives, one or more hard disks, one or more solid state drives, one or more optical drives, etc. In some embodiments, memory 210 can have encoded thereon a computer program for controlling operation of computing device 110. In such embodiments, processor 202 can execute at least a portion of the computer program to execute communication platform client application 102, to transmit audio and/or video data to a remote server (e.g., server 120-1), to receive audio and/or video data from a server (e.g., server 120-1), etc.

In some embodiments, server 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over communication network 130 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 120. In such embodiments, processor 212 can execute at least a portion of the server program to transmit information and/or content (e.g., audio, video, user interfaces, graphics, tables, etc.) to one or more computing devices 110, receive information and/or content from one or more computing devices 110, receive instructions from one or more devices (e.g., a personal computer, a laptop computer, a tablet computer, a smartphone, etc.), analyze data received from one or more computing devices (e.g., to generate a transcript), analyze engagement by various participants in a meeting, etc.

FIG. 3 shows an example 300 of a process for managing education processes in a distributed education environment in accordance with some embodiments of the disclosed subject matter. At 302, process 300 can receive user-generated content from multiple sources (e.g., computing devices 110, telephones) that represents real-time communication between participants in a remote meeting (e.g., a distributed educational process). For example, as described above in connection with server 120-1, process 300 can receive audio data and/or video data captured by computing devices associated with participants, and can transmit the content of the received audio data and/or video data to other computing devices participating in the meeting (e.g., all the computing devices or a subset of all computing devices participating in the meeting). In some embodiments, a participant (e.g., a meeting organizer, an instructor, etc.) can control which portion or portions of a meeting are recorded, and which portions are not recorded. For example, an instructor can initiate recording at a beginning of a lecture or discussion, and can stop recording during a break (e.g., by transmitting an instruction to record to a communication platform server, such as server 120-1, via a client application being executed by a computing device, such as computing device 110-1). As another example, an instructor can provide instructions to disregard or delete a portion of a recording (e.g., after a recording has been made, after a meeting has ended, etc.) when generating a meeting transcript and/or an analysis of a meeting (e.g., by transmitting an instruction to a server executing a communication analysis application, such as server 120-1 or 120-2 executing communication analysis application 106, via a client application being executed by a computing device, such as computing device 110-1). In some embodiments, process 300 can receive user-generated content at 302, and distribute at least a portion of the content (e.g., audio, video, and/or other content) to computing devices associated with participants (e.g., to facilitate the meeting) without recording the user-generated content and/or metadata about the user-generated content.

At 304, process 300 can generate data identifying participants in the meeting and details of the meeting. For example, process 300 can generate a file that includes details about the meeting, such as identifying information associated with the meeting (e.g., a semantically meaningful meeting name, a link used to join the meeting, a programmatically generated meeting identifier, etc.), the time the meeting started, the time the meeting ended, the length of the meeting, identifying information associated with participants in the meeting (e.g., real names, usernames, email addresses, anonymized and/or encrypted user identifying information, etc.), when the participants joined and/or left the meeting, when each participant's audio was muted (e.g., by the participant, by an organizer of the meeting, etc.), whether instructions to present icons (e.g., emojis) and/or alerts (e.g., a request to be unmuted) were received from a computing device associated with a participant, whether there was any text-based communication between two or more participants associated with the meeting (e.g., one or more chat messages), etc. In some embodiments, process 300 can identify participants in the meeting based on login information provided when a user joined a meeting. For example, a user login to an application (e.g., communication platform client application 102) that is used to join the meeting, and the login information (e.g., a username, an email address, a telephone number, etc.) can be used to identify the participants.

In some embodiments, the file generated by process 300 at 304 can be referred to as a meeting record. In some embodiments, a meeting record can be generated by a communication platform server (e.g., by communication platform server application 104). In some embodiments, the file and/or data generated by process 300 at 304 can be accessible by authorized computing device (e.g., server 120-2, a particular computing device 110) and/or process 300 can store the file at a particular storage location specified by an organizer of the meeting (e.g., at a particular cloud storage location specified by the meeting organizer). In some embodiments, the file generated by process 300 at 304 can be in any suitable format. For example, the file can be a .csv file, a .vtt file, an .xls file, an HMTL file, an XML file, an MP4 file, or any other suitable format that can be used to report details of a meeting. In some embodiments, data generated by process 300 at 304 can be made available via an API. For example, an authorized computing device (e.g., server 120-2, a particular computing device 110) can request at least a portion of a meeting record via the API, and data included in the meeting record can be provided to the authorized computing device using any suitable technique or combination of techniques (e.g., via one or more JavaScript Object Notation (JSON) data objects). In some embodiments, data can be generated at 304 in real time or near real time (e.g., before a meeting has ended), and can be provided as a stream of data during the meeting.

In some embodiments, process 300 can receive data identifying participants in the meeting and details of the meeting at 304 (e.g., 304 can be executed by a different computing device than a device that performs one or more other portions of process 300). In some embodiments, process 300 can receive one or more portions of a meeting record via an API.

At 306, process 300 can analyze the user-generated content received at 302 to extract information indicative of user engagement with the meeting (e.g., participant engagement with the distributed educational process). For example, in some embodiments, process 300 can generate a transcript of the meeting, which can include times at which audio was received (e.g., when words in the transcript were spoken), identifying information (e.g., names, usernames, email, etc.), and the content of audio (e.g., words spoken by each participant). Additionally or alternatively, in some embodiments, process 300 can generate a file that includes information such as times and identifying information, but may omit the content of the audio. For example, process 300 can generate a log identifying when each participant spoke, without recording the content of the audio (e.g., without generating a transcript). In some embodiments, the file generated by process 300 at 304 can be in any suitable format. For example, the file can be a .vtt file, a .txt. file, a .pdf file, a .xls file, a .doc file, an HMTL file, an XML file, an MP4 file, or any other suitable format that can be used to report the times, identities, and content of the speech of meeting participants.

In some embodiments, the file generated by process 300 at 306 (e.g., a transcript or log associated with the meeting) can be referred to generally as a meeting transcript. In some embodiments, a meeting transcript can be generated by a communication platform server (e.g., by communication platform server application 104) and/or by a different server (e.g., server 120-2) that may be associated with a participation analysis service that is not affiliated with the provider of the communication platform. In some embodiments, the file generated by process 300 at 306 can be accessible by authorized computing device (e.g., server 120-2, a particular computing device 110) and/or process 300 can store the file at a particular storage location specified by an organizer of the meeting (e.g., at a particular cloud storage location specified by the meeting organizer). In some embodiments, the meeting transcript can be generated from only a portion of a meeting that was recorded, and portions of a meeting that were not recorded can be omitted from the meeting transcript.

In some embodiments, process 300 can receive a transcript of the meeting at 306 (e.g., 306 can be executed by a different computing device than a device that performs one or more other portions of process 300).

At 308, process 300 can generate one or more educational effectiveness indicators for individual participants. For example, process 300 can determine total speech time by each participant in a meeting using the transcript (or log) generated at 306. As another example, process 300 can determine the number of speech instances by each participant in a meeting using the meeting transcript (or log) generated at 306. As another example, process 300 can generate a transcript specific to a particular participant (e.g., by associating each speech instance with words attributed to the participant during the time corresponding to the speech instance).

In some embodiments, educational effectiveness indicators for individual participants can be generated for a series of meetings (e.g., after each meeting concludes), which can be used to illustrate trends in such indicators for a participant over time. For example, process 300 can calculate educational effectiveness indicators for each student in a series of individual classes that collectively correspond to a course. In such an example, educational effectiveness indicators for a particular student can be plotted over time to illustrate trends in that students engagement over time.

Educational effectiveness indicators generated at 308 can be used for a variety of purposes, such as providing feedback and/or evaluation of students. For example, such indicators can provide a relatively objective and accurate mechanism to incorporate class participation into grades, a common practice in discussion-based courses that is often based on an instructor's personal impressions and memory. As another example, such indicators can be used by an instructor and/or student to evaluate a student's participation. In a more particular example, an instructor can utilize information provided via such indicators to coach students on their participation. In another more particular example, a student can utilize information provided via such indicators as relatively objective and accurate data to track their own participation.

At 310, process 300 can receive demographic information about participants in a meeting. As described below, the demographic information can be used to aggregate individual educational effectiveness indicators for groups of participants that share one or more demographic characteristics. Patterns that emerge in aggregated educational effectiveness indicators can be used for a variety of purposes. For example, patterns in aggregated indicators can be used by an instructor to monitor their own performance (e.g., to monitor whether they exhibit a calling pattern, to monitor the pace of their class, and to monitor their own speech time, which may or may not be classified as speech when instructor is lecturing and speech when the instructor is leading, and/or participating in, a discussion. Patterns and trends in the data can act as feedback to an instructor on the effectiveness of their in-class pedagogy, which can lead to improvements in the instructor's behavior.

In some embodiments, process 300 can receive the demographic information from a server associated with an organization or institution with which at least a portion of the participants are affiliated. For example, for university course, process 300 can retrieve demographic information from a database of demographic information maintained by the university (e.g., a registration database). In some embodiments, the demographic information can be organized into one or more files or documents. For example, in some embodiments, process 300 can query a database of demographic information using identifying information of participants, and can receive a file and/or document that includes demographic information associated with each participant in a meeting. In a more specific example, process 300 can the demographic information as a .csv file, an .xls file, a .txt. file, a .vtt file, a .pdf file, a .doc file, an HMTL file, an XML, an MP4 file, or any standard format that reports the details of the participants. In some embodiments, data received by process 300 at 310 can be made available via an API. For example, an authorized computing device (e.g., server 120-2, a particular computing device 110) can request at least a portion of demographic information via an API, and demographic can be provided to the authorized computing device using any suitable technique or combination of techniques (e.g., via one or more JSON data objects).

Additionally or alternatively, in some embodiments, process 300 can receive the demographic information from any other suitable source, such as manual entry by a user of data into a document (e.g., to supplement missing demographic information, to provide demographic information that is not available in a demographic database), from local memory specified by a user (e.g., a hard drive, a USB drive, etc.), from remote storage specified by a user (e.g., a cloud storage location).

In some embodiments, the demographic information can include any suitable data about each participant, such as identifying information and a value associated with each of one or more demographic characteristics of interest (e.g., gender, English-as-a-second-language, degree program, etc.). In some embodiments, demographic information can be received one time for a planned series of meetings (e.g., a university course).

In some embodiments, supplemental demographic information (which is sometimes referred to herein as class demographic information) can be received at 310, which can include new and/or updated demographic information. For example, if there have been any changes to the demographics of participants, changes in which participants are associated with a series of meetings, and/or any other relevant changes, process 300 can receive supplemental demographic information. In such an example, the supplemental demographic information can include demographic information for all participants, including demographic information that has not changed. Alternatively, the supplemental demographic information can changes to demographic information, and may omit demographic information that has not changed.

At 312, process 300 can correlate the demographic information received at 310 with individual educational effectiveness indicators generated at 308. For example, process 300 can associate educational effectiveness indicators for each participant with demographic information associated with the participant.

At 314, process 300 can generate one or more aggregate educational effectiveness indicators at various levels of granularity, and/or for various demographic categories. For example, process 300 can aggregate educational effectiveness indicators for a class (e.g., a single class meeting in a series of meetings that collectively make up a course), for a course (e.g., a collection of classes), for a degree program or programs, for grade levels, for a subdivision of an educational institution (e.g., a department, a school, a college, etc.), for a group of subdivisions (e.g., science, technology, and mathematics), for an entire educational institution at any other suitable level of granularity. As another example, process 300 can aggregate educational effectiveness indicators within a level of granularity (e.g., at a class level, at a course level, at a degree program level, etc.). In a more particular example, process 300 can aggregate total speech time for students in a particular class, and can also aggregate total speech time based on demographic categories within the class, and can generate aggregate educational effectiveness indicators associated with a demographic category. In another more particular example, process 300 can determine aggregate speech time in each meeting in a series of meetings (e.g., each class in a course) for participants that speak English as a second language (ESL) and for students that speak English as a first language. In such an example, process 300 can determine average (e.g., mean) speech time for the demographic across the series of meetings, a distribution of speech times for the demographic (e.g., a histogram of speech times for each student in a course that falls into the demographic, etc.), etc. Additionally, in some embodiments, process 300 can determine the proportion of the participants that fall into the demographic category (e.g., the ratio of participants that speak English as a second language to total participants).

At 316, process 300 can generate reports indicative of engagement at various levels of granularity (e.g., for individual participants, for a particular meeting/class, for a particular group or series of meetings/course, for a department, for an organization and/or institution, etc.) and/or across various demographic groups. For example, a report can include information aggregated across a set of meetings (e.g., aggregated over a series of classes). As another example, a report can include aggregated educational effectiveness indicators for each meeting, and can plot the aggregated educational effectiveness indicators for each class in a time series.

In some embodiments, process 300 can cause the report(s) to be presented to a user. For example, the report can be presented to a user in response to a user navigating to the report in a graphical user interface (e.g., a web page, an application, an operating system). As another example, the report(s) and/or a link to the report(s) can be presented to a user via a communication directed to the user (e.g., an email, a message, etc.). In some embodiments, process 300 can present the report as a static document. Additionally or alternatively, process 300 can present the report via a dynamic user interface that can accept input that causes different portions of the report to be presented. Note that, in some embodiments, process 300 can control which information is included in a report based on the identity and/or role of a user interacting with process 300. For example, process 300 can present a student user with information associated with that user, and can inhibit particular (e.g., non-aggregated) information associated with other students from being presented. As another example, process 300 can present an instructor user with information associated with courses taught by the instructor, and can inhibit particular (e.g., non-aggregated) information associated with other courses and/or identifiable information associated with students (e.g., non-encrypted user identification information) from being presented.

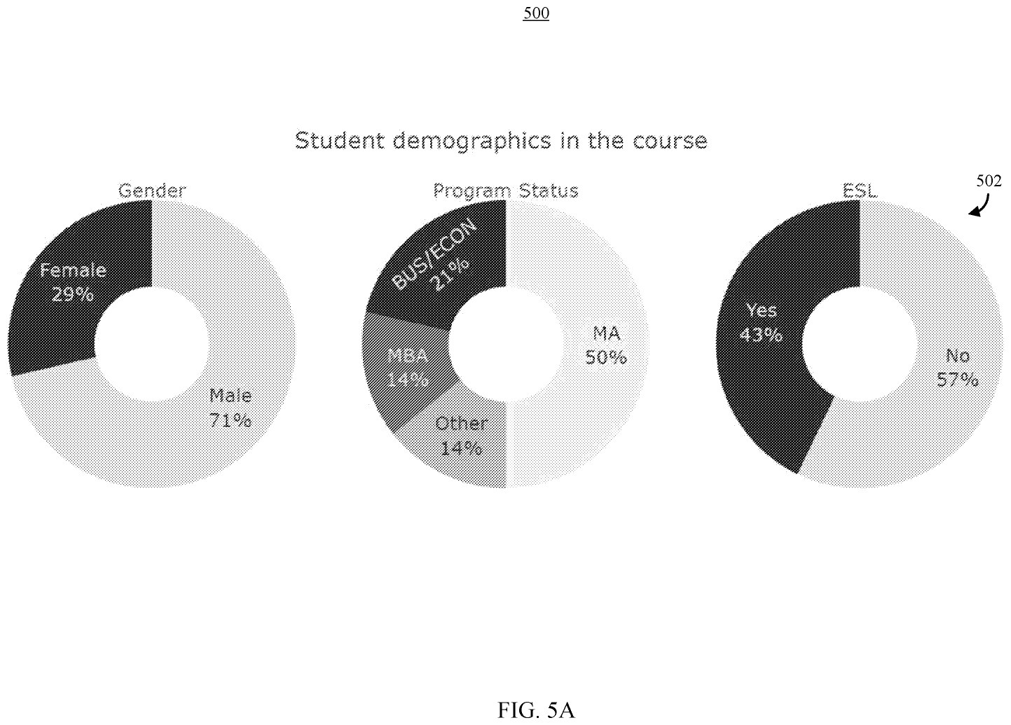

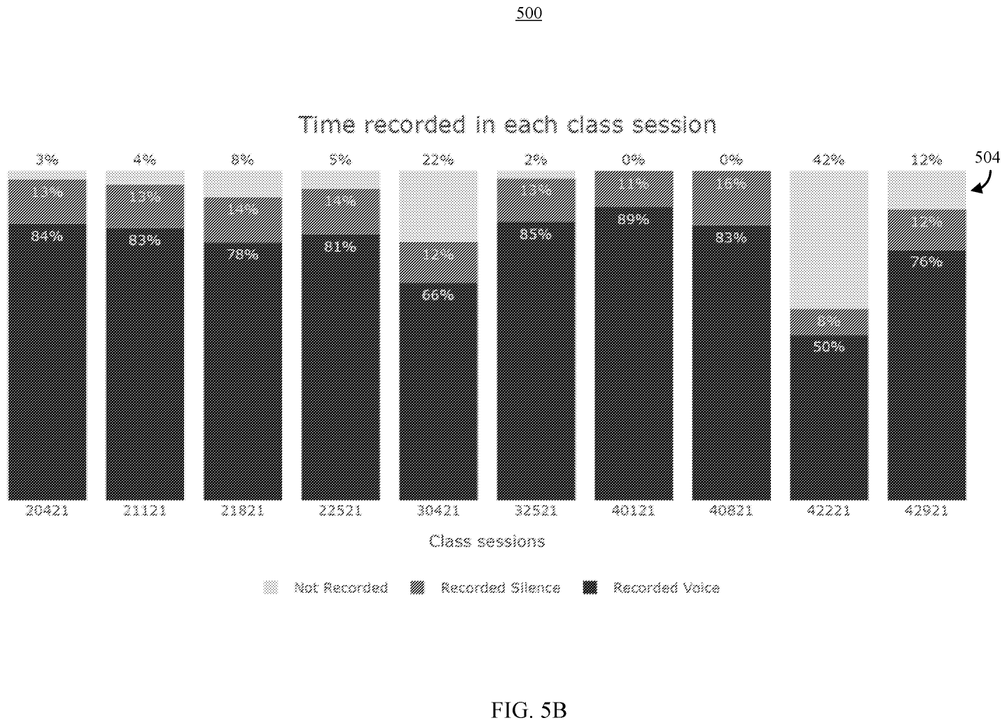

In some embodiments, process 300 can include any suitable information in a report or reports, which can include individual and/or aggregated educational effectiveness indicator data. For example, a report can illustrate a share of total class speech time of particular types of participants (e.g., an instructor, a guest speaker, students, etc.). As another example, a report can illustrate a share of total class speech time aggregated by demographic category (e.g., gender, ESL status, degree program, etc.), which can be presented in a connection with an average share of participants that fall into the demographic category (e.g., a ratio of female participants to total participants). FIG. 5A, described below, includes total participation by gender per class.

As yet another example, a report can illustrate a total number of speech instances of particular types of participants and/or participants belonging to particular demographic category or categories.

As still another example, a report can illustrate an average speech time per instance of particular types of participants and/or participants belonging to particular demographic category or categories.

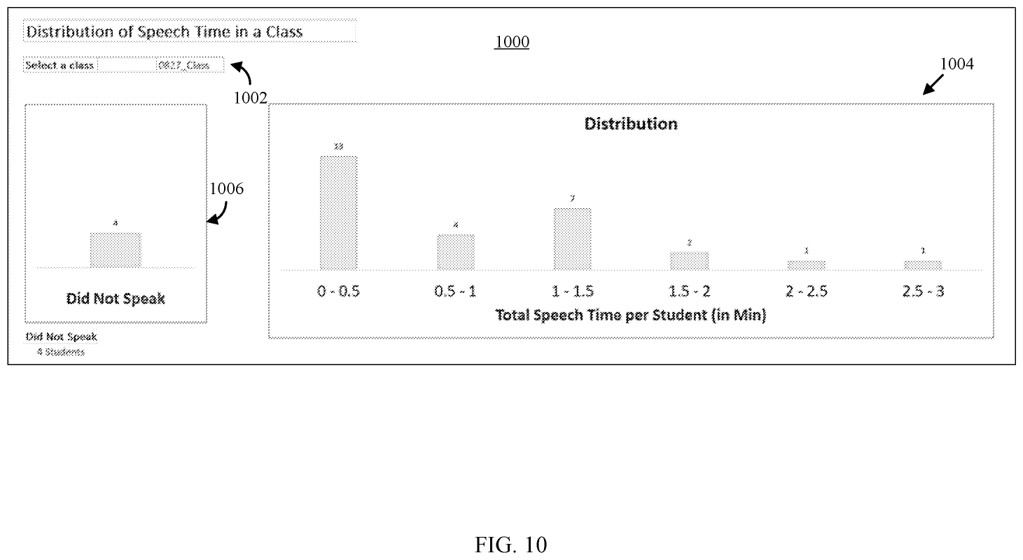

As a further example, a report can illustrate a distribution of total speech times of particular types of participants and/or participants belonging to a particular demographic category or categories. In a more particular example, the report can include a number of participants (e.g., of a particular type, belonging to a particular demographic category, etc.) that spoke for a total amount of time that falls into a particular range. Such ranges can include did not speak (e.g., speech time of zero), 0-30 seconds, 30-60 seconds, etc. FIG. 10, described below, includes a distribution of total speech time for students.

As another further example, a report can illustrate a distribution of speech instances of particular types of participants and/or participants belonging to a particular demographic category or categories.

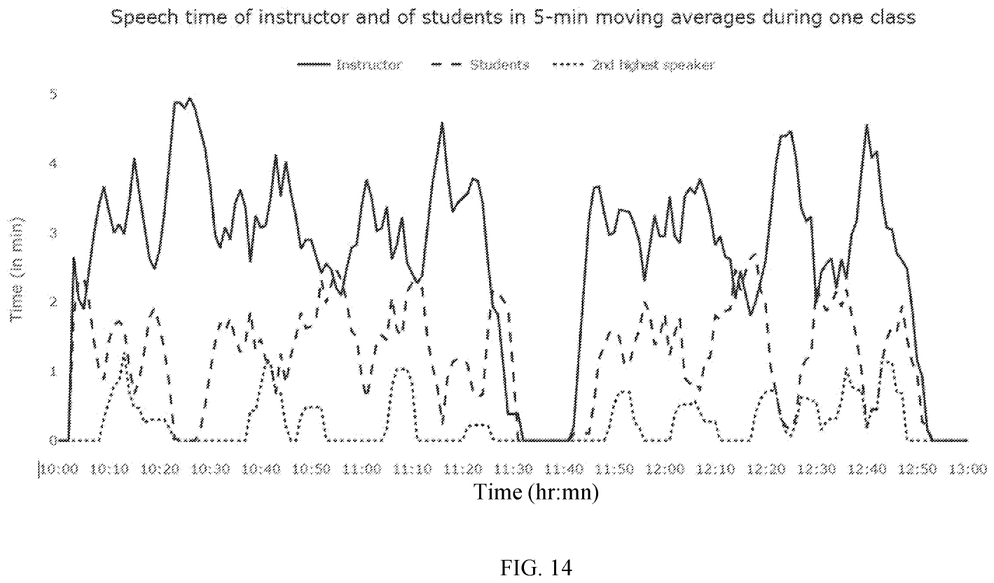

As yet another further example, a report can illustrate patterns of discussion within a particular meeting (e.g., within a particular class session). FIGS. 14-17, described below, includes illustrations of patterns of discussion.

As still another further example, a report can illustrate a cumulative measures of total speech time, speech instances, etc., over time (e.g., across classes), which can be illustrated for particular types of participants and/or for participants belonging to a particular demographic category or categories. In a more particular example, the report can include the total (or average) total speech time for ESL students and non-ESL students to date.

In some embodiments, a report for an individual participant can include aggregated data that can be used as a basis for comparison between the individual's engagement and engagement by other participants. For example, a report can include total speech time by a participant in each meeting and average speech time for all participants, average speech time for participants in a same demographic category as the individual, etc. In some embodiments, a report for an individual participant can include text representing the student's participation. For example, all text in transcripts for classes that is attributed to a student can be included in a report for that student.

In some embodiments, a report can include information at any suitable level of granularity. For example, a report can be about a particular meeting. As another example, a report can be about a series of meetings (e.g., classes in a course, classes in a particular section of a course). As yet another example, a report can be about participants associated with a particular group or part of an organization or institution. In a more particular example, a report can be generated across a department or other group. In the context of a school, a report can be generated for students and/or courses in the computer science department, in the business school, etc. Additionally, a report can be generated for first year students (e.g., freshman), second year students (e.g., sophomores), etc. In the context of a business, a report can be generated for meetings related to sales and/or for employees in sales, for meetings related to engineering and/or employees in engineering. As still another example, a report can be about participants associated with an organization or institution. In a more particular example, a report can be generated with educational effectiveness indicators aggregated across a university.

Similarly, number of speech instances, distribution of total speaking time, distribution of speech instances, and/or any other indicators can be aggregated at various levels of granularity.

In some embodiments, confidential data and/or personally identifying information can be omitted, encrypted, or otherwise obscured in certain reports, and can be presented in other types of reports. For example, when the identity of individual participants is needed by a user (e.g., an instructor) to provide appropriate feedback to particular participants (e.g., particular students), the names of individual participants can be revealed and/or presented. In a more particular example, an instructor that is determining a grade for a student that is partially based on participation may need to see a report for the individual student with the student's name.

In some embodiments, educational effectiveness indicators can be analyzed to discover ways to improve the management of online discussion (e.g., across multiple courses, instructors, and/or students). For example, educational effectiveness indicators can be used to predict the effect of gender, ESL status, degree program, etc., on speech time and/or speech instances of for participants. In some embodiments, such findings can be used to predict an estimated participation rate (e.g., in total speech time per class) for a given student and/or for students in a particular demographic group(s). In some embodiments, reports that illustrate a comparison of the predicted participation rate and each student's observed participation rate, can be used by students and/or instructors to monitor progress and goals for each student, which can lead to increased student engagement.

In some embodiments, one or more reports can be presented using a dashboard user interface that a user can navigate to cause reports related to different individuals and/or groups to be presented at various levels of granularity. For example, process 300 can cause reports to be presented using an instructor dashboard user interface, which can include data for one or more courses and/or one or class within a course. An instructor dashboard can include data for all classes and all students in a course. A visual representation of participation patterns and rankings by student performance can serve as aids in grading and feedback. Such information can be useful in evaluating pedagogy across courses and over time. In some embodiments, student names can be identified to the instructor in such a dashboard (e.g., to facilitate use of the information for grading).

Additionally or alternatively, an instructor dashboard can include data on each student for each class (e.g., speech time for individual students and a class average, speech instances and class average, etc.). A visual representation of participation patterns and text of student speech in each class can serve as aids in grading and feedback.

As another example, process 300 can cause reports to be presented using a student dashboard that includes data on a particular student's performance (e.g., compared to average) in one or more courses. This analysis can be useful feedback that can be made available to students. Presentation of identified individual data can be restricted to the student associated with the data.

As yet another example, process 300 can cause reports to be presented using a school dashboard that includes aggregated data on class participation across courses and by student demographic characteristic. In some embodiments, individual student data and names can be revealed in the school dashboard, which can be restricted to school administrators or other individuals that are authorized to access individual student data.

In some embodiments, process 300 can generate and/or present a report or reports related to a particular student and/or a particular group of students at one or more levels of granularity along various dimensions. For example, process 300 can aggregate data across classes to generate course data for a student or group(s) of students (e.g., to generate data for a course). As another example, process 300 can aggregate data across courses to generate aggregate data for a student or group of students across multiple courses (e.g., to generate data for students at a particular grade level, for students in a particular degree program, for students in a particular department, for classes taught by a particular faculty member, for a subunit of the organization, for the entire organization, etc.).

In some embodiments, data for a particular student or group that is aggregated at a particular granularity level can be compared to data for another student or group of students that is aggregated at a comparable granularity level. For example, participation by a student or group of students can be compared to participation by another student or group of students at a class level, at a course level, at a grade level, at a degree program level, at a department level, etc.

In a particular example, process 300 can generate a report related to a particular student's participation in a class, in a course (e.g., including multiple classes), in multiple courses (e.g., including multiple classes from multiple courses), in classes/courses associated with a particular department, in classes/courses associated with a particular department, in classes/courses associated with a particular faculty member, in particular types of classes (e.g., based on class size, based on whether the class is a discussion or lecture, etc.).

As another example, process 300 can generate a report related to participation by a group of students (e.g., students associated with a particular demographic group(s)) in a class, in a course (e.g., including multiple classes), in multiple courses (e.g., including multiple classes from multiple courses), in classes/courses associated with a particular department, in classes/courses associated with a particular faculty member, in particular types of classes (e.g., based on class size, based on whether the class is a discussion or lecture, etc.), etc.

As yet another example, process 300 can generate a report or reports that can be used to compare two or more students and/or groups at a particular level.

In some embodiments, process 300 can generate and/or update a report (e.g., in an instructor dashboard) related to participation in a particular meeting (e.g., a particular class meeting) in real time or near real time. For example, in some embodiments, process 300 can generate and/or update a report indicating: which meeting participant(s) have and/or have not spoken; which participant(s) have and/or have not been called on; historical information indicative of participation in previous meetings or a class and/or indicative of how current participation by a participant (e.g., student) compares to that participant's usual participation; and/or any other suitable data. In such embodiments, student identifying information can be unencrypted selectively for users who are authorized to have access to student information, while maintaining encryption in other reports to other users.

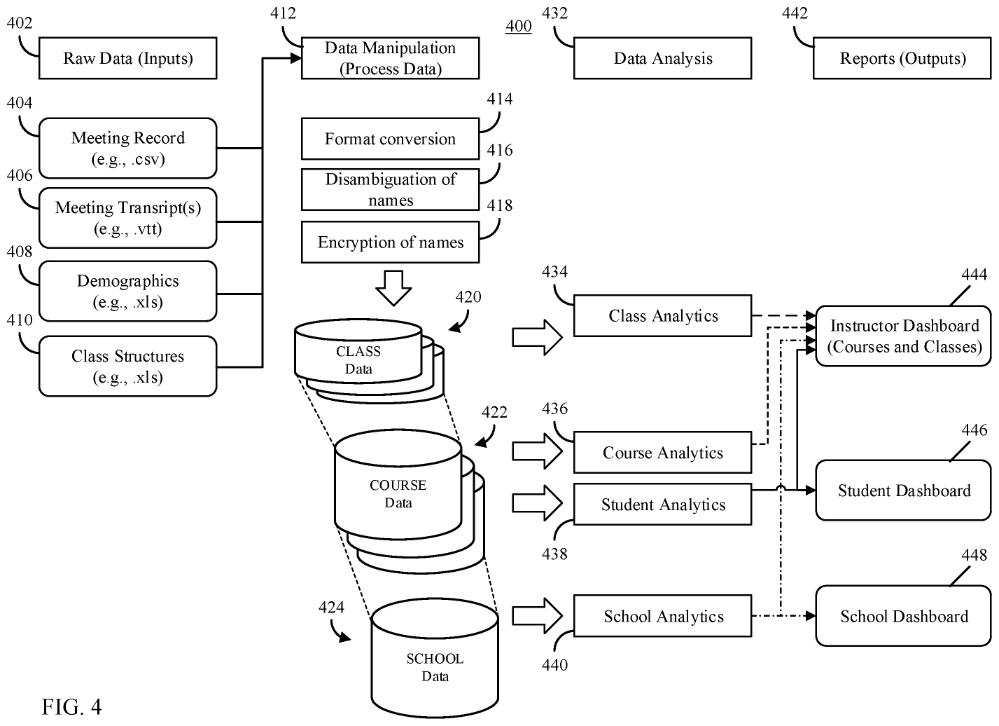

FIG. 4 shows an example 400 of a flow for managing education processes in a distributed education environment in accordance with some embodiments of the disclosed subject matter. As shown in FIG. 4, various data 402 from various sources can be used to generate educational effectiveness indicators. For example, data 402 can include a meeting record 404 and a meeting transcript 406. As described above in connection with process 300 of FIG. 3, meeting record 404 can includes details about one or more meetings (e.g., meetings that are at least partially virtual), and transcript 406 can include identifying information of speakers and content of audio spoken.

As another example, data 402 can include demographic information 408 about the participants in the course or in a particular meeting. As described above in connection with FIG. 3, demographic information can include characteristics of participants, such as gender, ESL status, degree program, degree status, etc. In some embodiments, demographic information 408 can include demographic information associated with a course (e.g., can include demographic information about students registered for a course).

As yet another example, data 402 can include class structure data 410 that can include supplemental and/or modified demographic information for a particular instance of a class (e.g., whether an outside speaker appeared) and/or any other suitable information associated with a structure of a particular class (e.g., whether the class was cut short, or extended). As described above in connection with FIG. 3, class structure data 410 can include changes to a list of participants in a particular class, information about guest speakers, instructors, etc.

In some embodiments, data 402 can be used at a data manipulation stage 412 to format data for use by a system for managing education processes in a distributed education environment (e.g., a system executing participation analysis application 108). In some embodiments, data manipulation stage 412 can include format conversion 414 in which the formats of different input files can be converted to common data structures and formats suitable for integrated analysis and reporting.

In some embodiments, data manipulation stage 412 can include disambiguation of names 416. For example, an official name of participants in school records may differ from a name and/or other identifying information (e.g., a username, an email address, a nickname, etc.) the student used in the online meeting. One or more disambiguation techniques can be used to sort and link the different names, so that information about a student can be consolidated and associated with the correct student.

In some embodiments, data manipulation stage 412 can include encryption of names 418. In any educational environment, whether it is distributed, online, traditional and in person, or a combination thereof, certain information associated with students (e.g., identifying information about students, student grades, enrollment status, and/or other protected information) are considered confidential information that can be shared only with authorized parties (e.g., instructor, teaching assistants, and each student themselves). In some embodiments, prior to manipulating and/or storing information from input data files (e.g., meeting record 404, meeting transcript 406, demographics 408, and class structures 410), student names can be replaced with confidential codes. Participants' data can be re-identified (e.g., by decrypting the confidential code) prior to presenting information to an authorized party. For example, participant data associated with students in a particular class can be re-identified prior to producing an instructor dashboard (e.g., as described below). As another example, participant data associated with a particular student can be re-identified prior to producing a student dashboard (e.g., as described below) to be presented to the particular student. In some embodiments, the data can be stored in school database 424 in connection with encrypted identifying information to be used for analyses and/or reports across courses, instructors, and/or students while maintaining confidentiality of student information.

In some embodiments, after input data has been processed, data for a class can be stored in a data store 420 associated with a class. In some embodiments, each data store 420 associated with a particular class can be aggregated in a data store 422 associated with a particular course. Data stores 422 associated with courses can be aggregated in a data store 424 associated with a department or school.

In some embodiments, data stored in data stores 420, 422, and/or 424 can be used at a data analysis stage 432 to generate educational effectiveness indicators. For example, data associated with particular class meetings (e.g., in data store 420) can be used to generate educational effectiveness indicators at a class level at a class analytics module 434. As another example, data associated with a series of classes (e.g., course data in data store 422) can be used to generate educational effectiveness indicators at a course level at a course analytics module 436 and/or at a student analytics module 436. As yet another example, data associated with multiple course (e.g., aggregated data in data store 424) can be used to generate educational effectiveness indicators relevant at a school level at a school analytics module 440.

In some embodiment, data analyzed at analytics modules 434, 436, 438, and/or 440 can be used at a data reporting stage 442 to present reports. For example, analyzed data from class analytics module 434, course analytics module 436, student analytics module 438, and/or school analytics module 440 can be used to populate an instructor dashboard 444, that can be used by an instructor to view reports about particular students, particular classes, particular courses, etc. In some embodiments, instructor dashboard 444 can present individual identifying information of particular students.

In some embodiments, data stores 420, 422, and/or 424 can be linked to each other through common variables (e.g. course numbers), dates of meetings, meeting participants, and/or any other suitable values. Alternatively, in some embodiments, all data can be stored in data store 424, and selected samples retrieved from data store 424 can be used to produce at data analysis stage 432, with different samples of data being used by different analytic modules (e.g., analytic modules 434, 436, 438, and/or 440) to produce different types of output reports (e.g. student analytics module 438 can retrieve information about a particular student from data store 424, and can use the information to populate student dashboard 446 for that student).

As another example, analyzed data from student analytics module 438 can be used to populate a student dashboard 444, that can be used by a particular student to view reports about that student's engagement in one or more courses.

As yet another example, analyzed data from school analytics module 440 can be used to populate a student dashboard 444, that can be used by an appropriate user (e.g., a school administrator) to view reports about engagement by students across different demographic groups at a school level (e.g., across multiple courses, multiple departments, etc.).

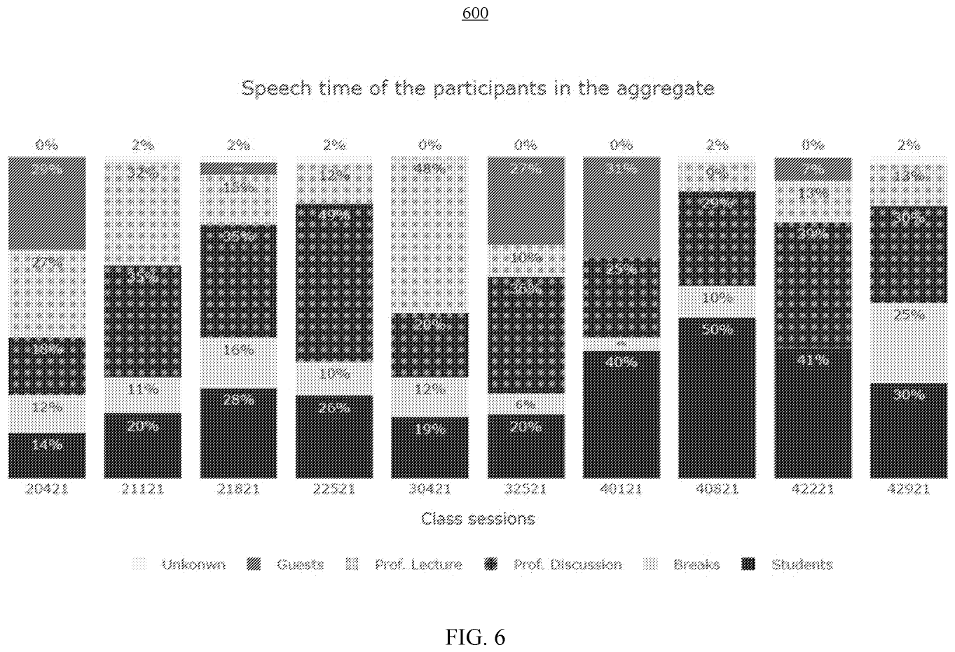

FIGS. 5A and 5B show an example 500 of at least a portion of a report generated using mechanisms described herein illustrating demographics of participants in a course, and portions of each class meeting that were recorded and analyzed. In some embodiments, report 500 can include user interface elements 502 that graphically illustrate average shares of participants having various demographic characteristics, and user interface elements 504 that graphically illustrate how much of each class was recorded and not recorded (and how much was recorded silence). For example, user interface elements 502 can illustrate demographic patterns of students in the course. As another example, user interface elements 504 can illustrate the share of class time that was recorded and submitted for analysis (e.g., used to generate a transcript and/or other information indicative of engagement as described above in connection with 306 of FIG. 3). As described above in connection with FIG. 3, meeting information (e.g., a meeting transcript) can correspond to a recorded portion(s) of a meeting, and a portion(s) that were not recorded can be omitted. For example, that instructors may choose to not record data a meeting for a full length of a class. The results shown in report 500 (and reports described below in connection with FIGS. 6-13) can be based on an analysis that pertains only to a portion that was recorded and/or used to generate a meeting transcript or other information about a meeting.

FIG. 6 shows an example 600 of a report generated using mechanisms described herein illustrating the share of speaking time various types of participants and/or by type of discussion. As shown in FIG. 6, report 600 can illustrate participation by different types of participants as a share of total participation. For example, report 600 can include bar graphs showing a percentage of total speech time attributed to students, total speech time attributed to an instructor(s), total speech time attributed to a guest speaker, and/or total speech time attributed to a student presentation. The instructor speech time can be further reported as speech time that represents lecturing (e.g., instructor speech times over 180 seconds of continuous speech), or discussion leadership (e.g., instructor speech times of less than 180 seconds). As another example, the share of instructor speech time can be measured in a given window of time (e.g., 5 minutes long windows), and the shares of instructor speech time can be taken to indicate lecture time, discussion time, break time, or other segments in the class. These windows of time can be plotted over time to show different segments in a given class. As yet another example, a block of silent time over a given amount (e.g., silences greater than 5 minutes) can be taken to indicate a break in the discussion or another interruption of the class process.

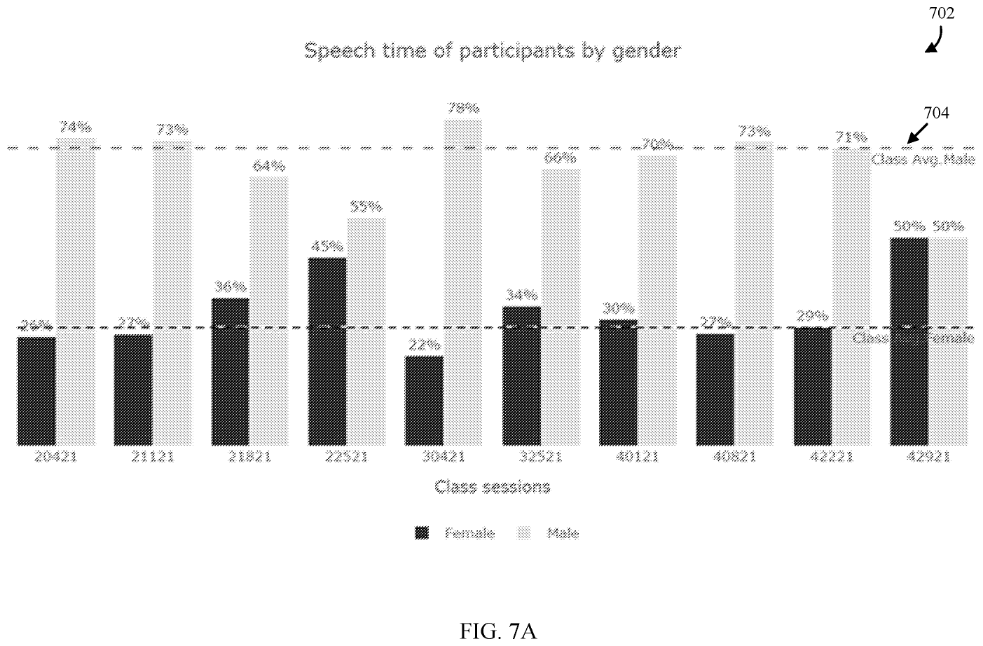

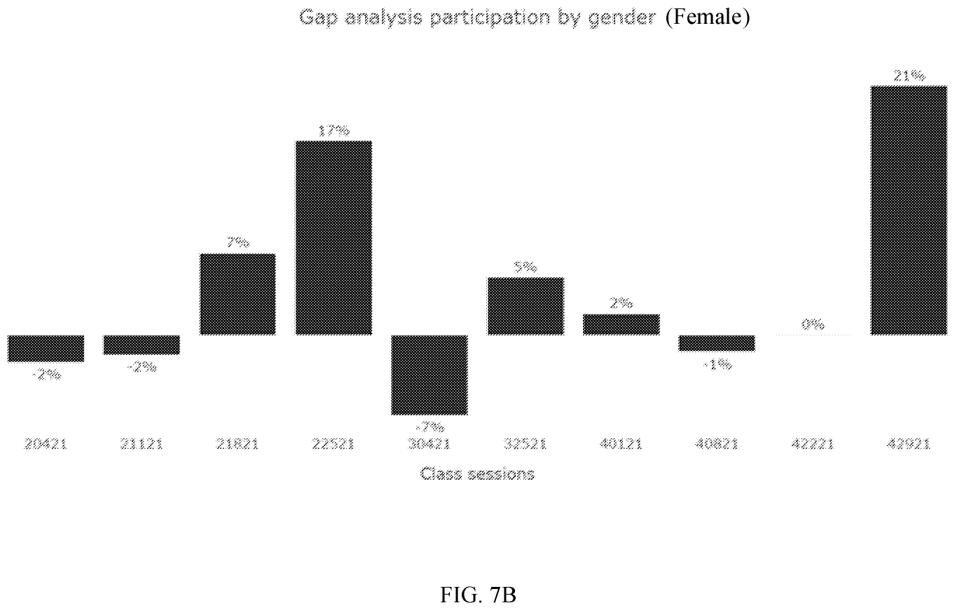

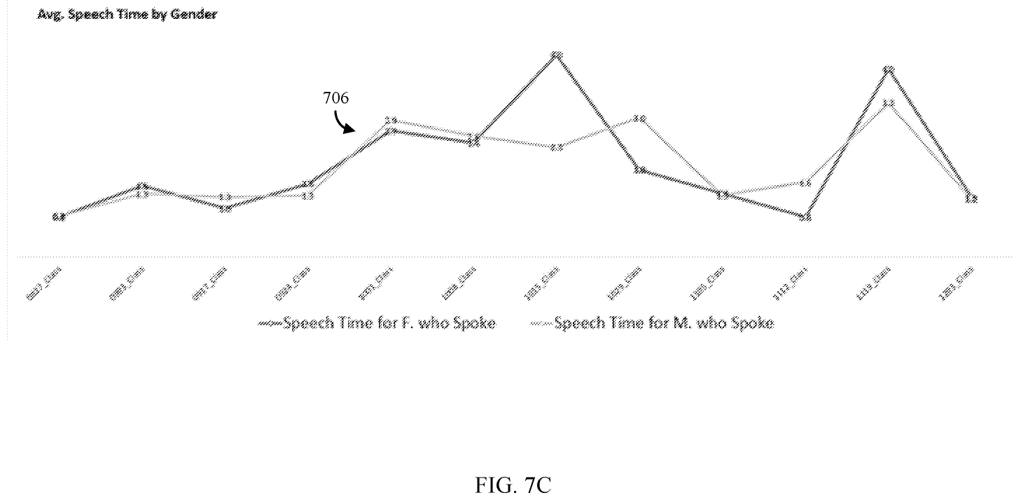

FIGS. 7A to 7C show examples of at least portions of reports generated using mechanisms described herein illustrating participation by female and male students on a per class basis. In some embodiments, reports can include a chart 702 showing the share of participation by gender out of total participation in each class, in comparison to an average level 704 (e.g., illustrated by a dashed line) of each gender in the class. For example, participation in each class can be shown using a bar graph, and a dashed line can represent an average participation across classes (e.g., shown by a line of the same color). In some embodiments, chart 702 can provide a basis for determining overall participation by demographic group and can illustrate changes in engagement over time. Such a chart can provide feedback to an instructor to help the instructor understand if certain classes elicited more or less engagement from students in particular demographic groups, and identify trends in engagement from students in particular demographic groups.

As shown in FIGS. 7A to 7C, participation can be quantified as the total speech time of the students associated with a particular demographic group, and as the average speech time of the students in a group who spoke. In some embodiments, reports can include a time series 706 illustrating the average speech time by each student who spoke by gender. Such a time series can provide feedback to an instructor to help the instructor understand if certain classes elicited more or less engagement from students, and/or from students in particular demographic groups, and identify trends in engagement. Chart 704 and time series 706 can provided additional information when considered together.

As shown in FIG. 7B, reports can include a chart showing a differential in participation for participants associated with a particular gender compared to average participation by participants of that gender. For example, each class can be associated with a gap value indicative of how much more (or less) participants of one gender (e.g., males, females, non-binary students, and/or any other suitable gender identifier) participated relative to average participation by participants of that gender. In the example shown in FIG. 7B, positive values indicate more speech time by female participants relative to the proportion of females in the class, while negative values indicate less speech time by female participants relative to the proportion of females in the class. In a more particular example, if female students make up 55% of a class, and female students speech time represents 50% of total speech time, the gap can be normalized based on the proportion of students, and calculated as −9% (a gap in participation of −5% normalized by the 55% share of female students). Note that mechanisms described herein can generate effectiveness metrics for any suitable number of demographic groups within a particular category. For example, although examples described herein describe examples comparing male and female genders, mechanisms described herein can be applied to additional or alternative gender identifiers. As another example, although examples described herein describe examples comparing ESL students and non-ESL students, mechanisms described herein can be applied to participants' first or preferred language (e.g., English, Spanish, Mandarin, etc.). As yet another example, any other student demographic characteristic can be used to analyze differential participation and/or generate educational effectiveness.

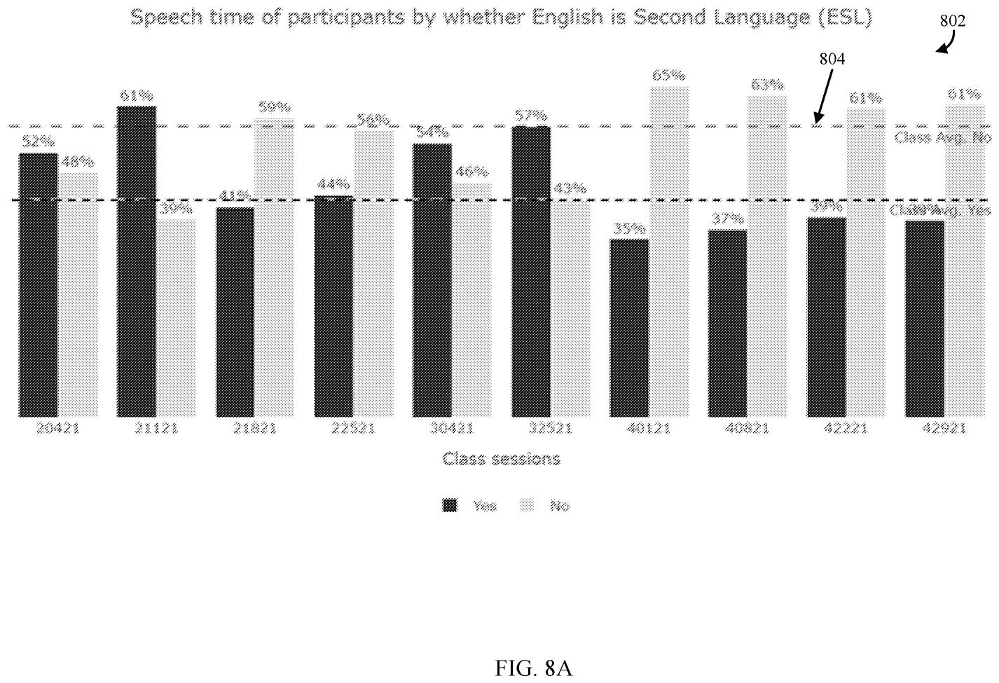

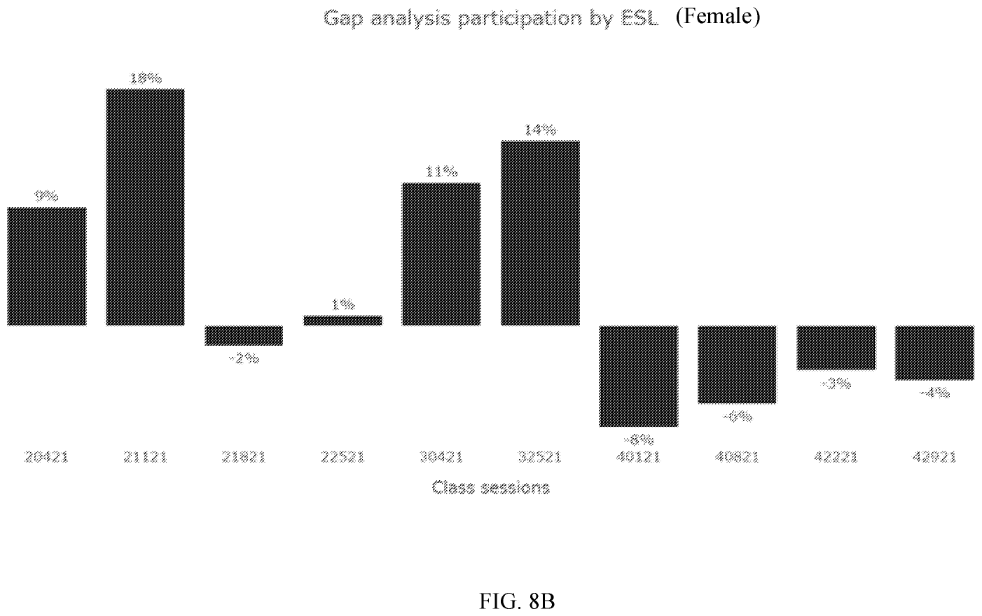

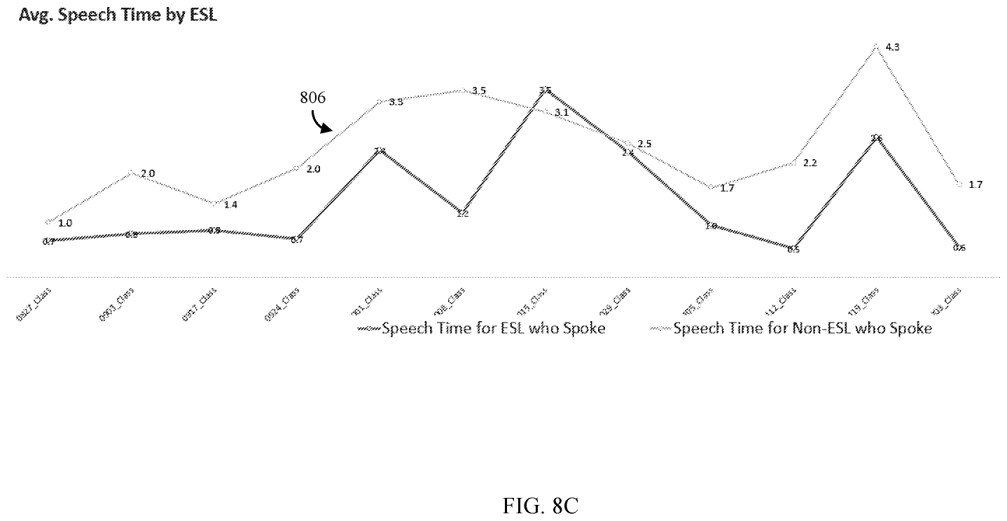

FIGS. 8A to 8C show examples at least portions of reports generated using mechanisms described herein illustrating participation by English as a first language students and English as a second language students on a per class basis. As shown in FIGS. 8A to 8C, report related to participation by English as a second language students can have a similar format to reports described above in connection with FIGS. 7A to 7C, but illustrate participation based on ESL status of students. Reports can include a chart 802 illustrating participation by ESL status out of total participation in each class, in comparison to an average 804 for all students with that status in the class. Additionally, reports can include a time series 806 illustrating the average speech time of those who spoke, separated by ESL status. In a more particular example, if ESL students make up 27% of a class, and ESL students speech time represents 35% of total speech time, the gap can be normalized based on the proportion of students, and calculated as +30% (a gap in participation of +8% normalized by the 27% share of ESL students).

As shown in FIG. 8B, reports can include a chart showing a differential in participation for participants associated with a particular ESL status compared to average participation by participants of that ESL status. For example, each class can be associated with a gap value indicative of how much more (or less) participants of one ESL status (e.g., students having English as a second language) participated relative to their proportion of the class. In the example shown in FIG. 8B, positive values indicate more speech time by ESL participants relative to their proportion of the class. , while negative values indicate less speech time by ESL participants relative to their proportion.

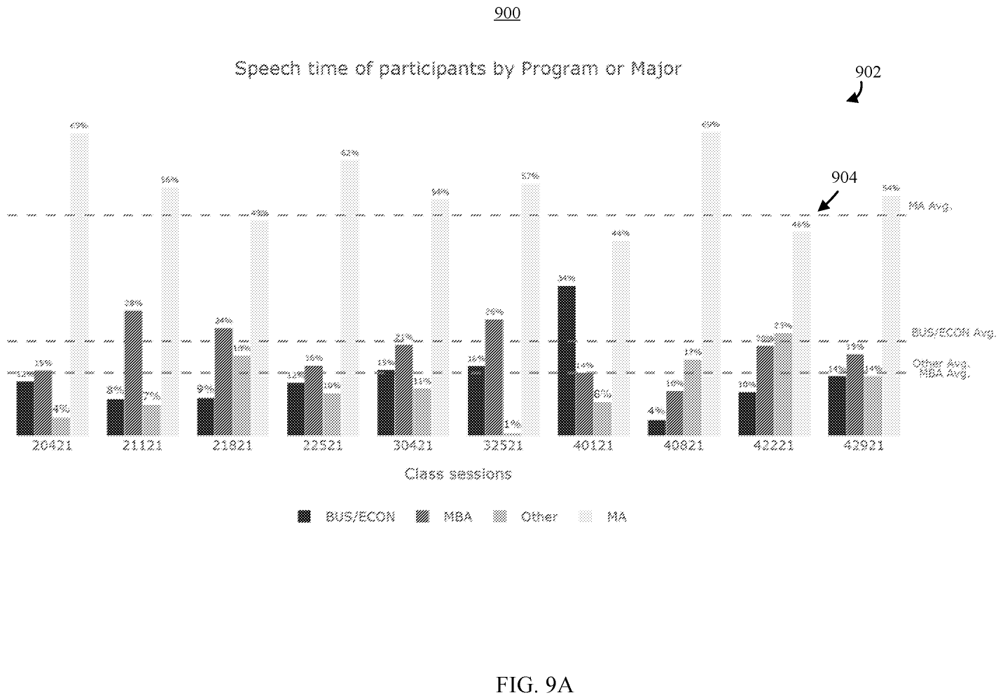

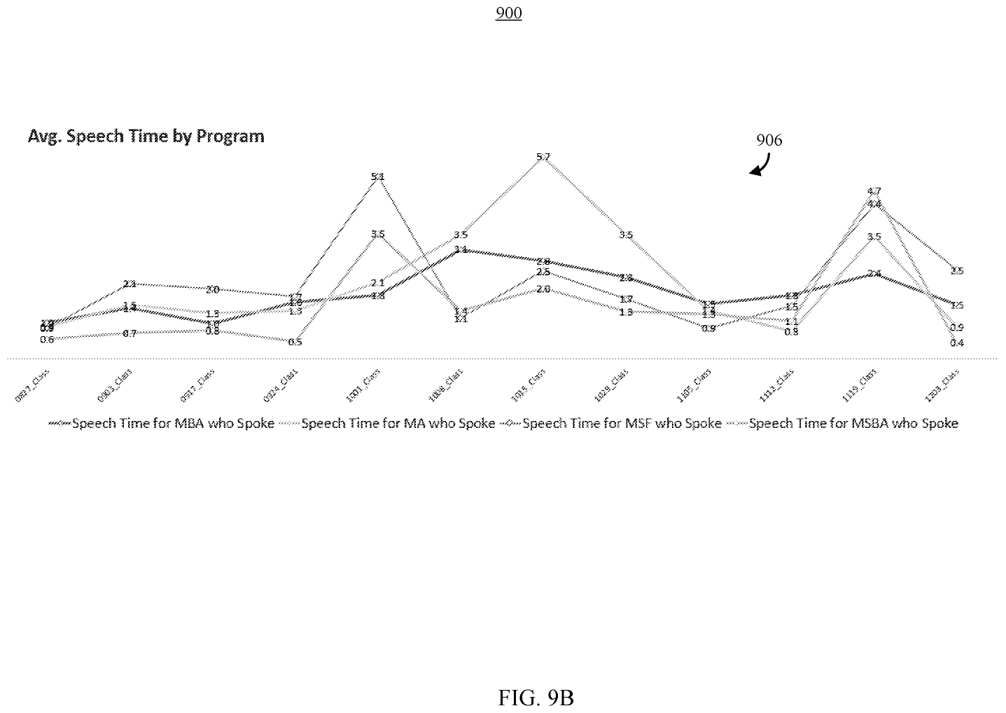

FIGS. 9A and 9B shows an example 900 of at least a portion of a report generated using mechanisms described herein illustrating participation by students in different degree programs. As shown in FIGS. 9A and 9B, report 900 has a similar format to reports 700 and 800, but illustrates participation by degree program of students. Report 900 can include a chart 902 illustrating participation by degree program out of total participation in each class, in comparison to an average 904 representation of students from each program in the class. Additionally, report 900 can include a time series 906 illustrating average participation by degree program.

FIG. 10 shows an example 1000 of a report generated using mechanisms described herein illustrating participation. Report 1000 can include a user interface element 1002 that can be used to select a particular class (e.g., by date), a distribution 1004 of total speech times (in minutes) of participants in the selected class, and a count 1006 of students that did not speak during the selected class. In some embodiments, the distribution of speech times can be indicative of the pace of the conversation in a class, and how widely distributed participation was. Although distribution 1004 is based on total speech time per student, such a distribution can also be used to illustrate a distribution of the speech instances. Additionally, to compare participation by different classes of students, similar distributions can be produced using different demographic samples. For example, an additional user interface element (not shown) can be used to select a demographic category, and distributions similar to distribution 1004 can each be used to present distribution for one or more groups of students having a particular demographic characteristic within the category.

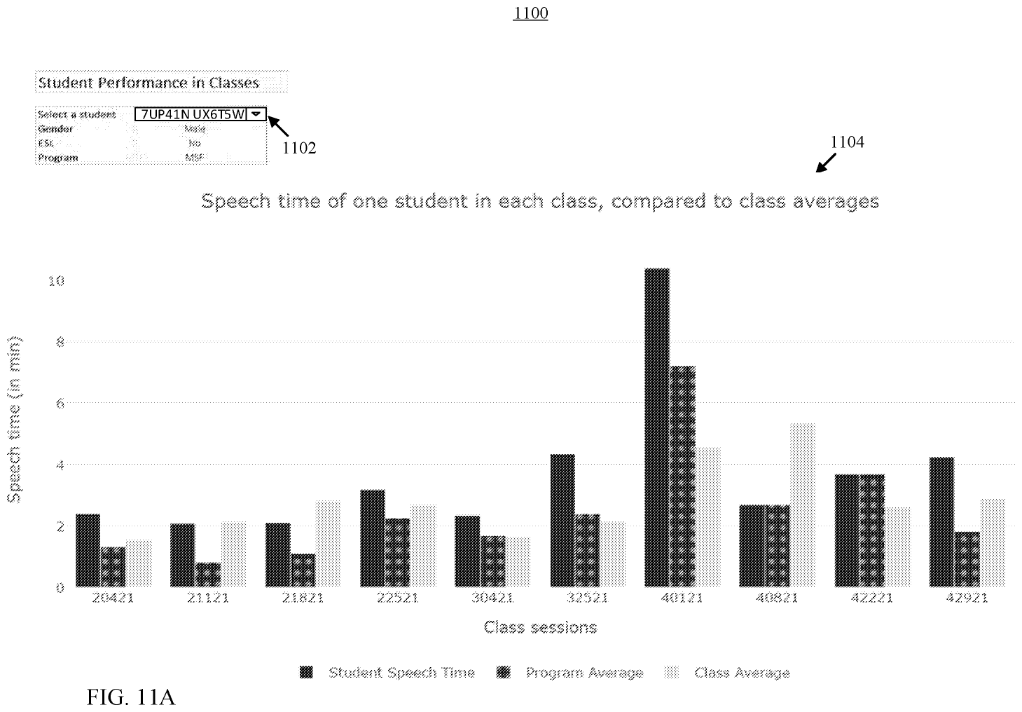

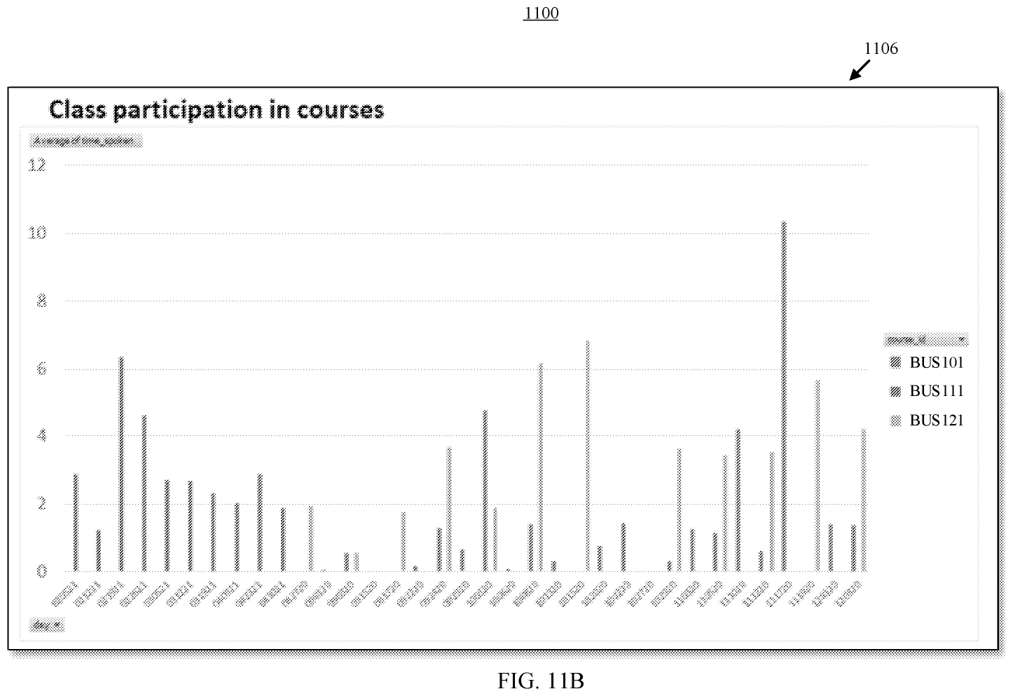

FIGS. 11A and 11B show an example 1100 of a report generated using mechanisms described herein illustrating participation by a particular student on a per class basis. As shown in FIG. 11A, report 1100 can include a user interface element 1102 that can be used to select a particular student for which to present a chart 1104. The illustration in report 1100 shows a student name as encoded by an encryption process (e.g., encryption process 418, as part of data manipulation 412). In reports presented to instructors (e.g., using instructor dashboard 444), the names of the students in that instructor's class can be shown in original form (e.g., by unencrypting encryption performed by process 418 to re-identify the student names). Note that in a student dashboard (e.g., student dashboard 446), intended only for one student, the user interface element 1102 can be omitted and/or replaced with a user interface element that can be used to select a course associated with a student. In such an example, individual data represented in report 1100 can be for only a student accessing the report, and the name of the student can be unencrypted or omitted.

Chart 1104 can illustrate total time spoken by the student selected via user interface element 1102, and average participation by students in the same demographic categories as the student. For example, if the selected student is male and non-ESL, chart 1104 can include the total participation by the selected student as a first bar associated with each class meeting, average participation by students in the same degree program as the student can be shown using a second bar associated with each class meeting, and average participation for all students in the class can be shown using a third bar associated with each class meeting.

As shown in FIG. 11B, report 1100 can include a chart 1106 that illustrates participation by a student (e.g., the student selected via user interface element 1102) in multiple courses over one or more time periods (e.g., one or more semesters, trimesters, terms, etc.).

In some embodiments, chart 1104 and/or chart 1106 can be presented to an instructor(s), administrator, etc. (e.g., in an instructor dashboard, in a school dashboard), and identifying information associated with the student may be encrypted. Additionally or alternatively, chart 1104 and/or chart 1106 can be presented to the student associated with the data (e.g., in a student dashboard).

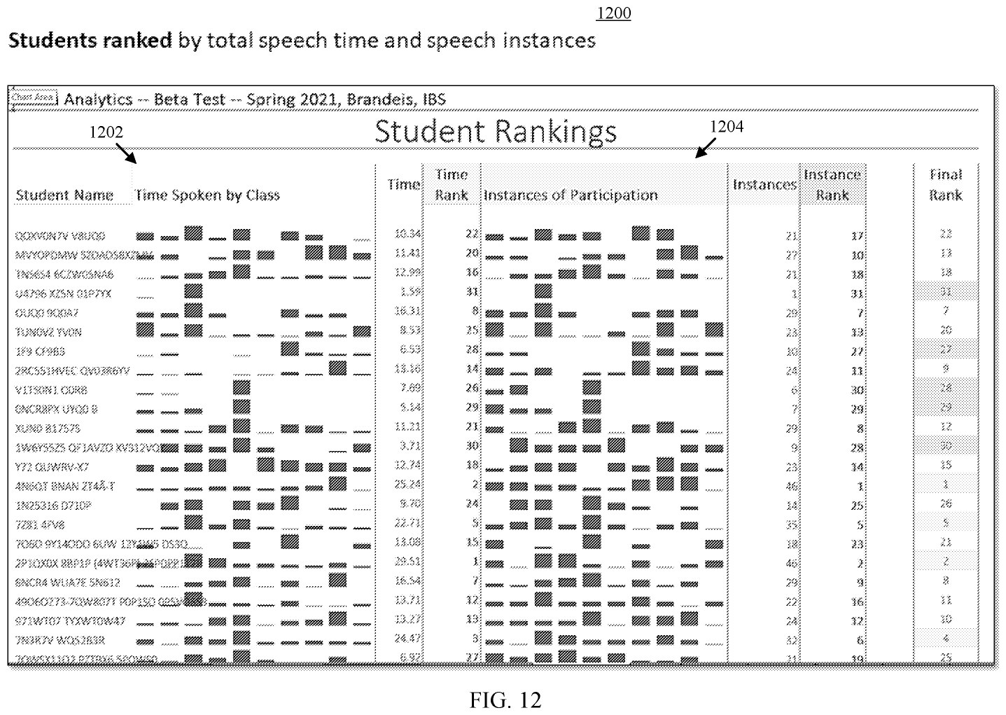

FIG. 12 shows an example 1200 of a report generated using mechanisms described herein illustrating the participation of all students in a course, on a per class basis. In this example, two measures of participation are shown graphically, the total speech time of each student in each class 1202, and the number of speech instances of each student in each class 1204. For each measure of participation, the total can be represented graphically (e.g., using a bar with height correlated to per class totals, as shown in the “time spoken by class” and “instances of participation” columns) for each class meeting (and/or overall, which is not shown), numerically (e.g., showing the total participation in time or number of instances across all classes as shown in the “time” and “instances” columns), and in ranked order (e.g., as shown in the “time rank” and “instance rank” columns). The example in FIG. 12 shows a visual representation of the participation pattern of each student, as well as a ranking of students that is based on the two participation measures. Information about total speaking time and/or number of speaking instances, such as the graphs, totals, and rankings in FIG. 12 can aid an instructor in various ways. For example, such information can aid an instructor in grading class participation for each student. As another example, such information can aid an instructor in evaluating the instructor's pedagogy and calling pattern. As yet another example, such information can aid an instructor in providing feedback to students. Note that “Final Rank” in FIG. 12 can be calculated as an average of the time rank and instance rank (e.g., a simple average, a weighted average, etc.).

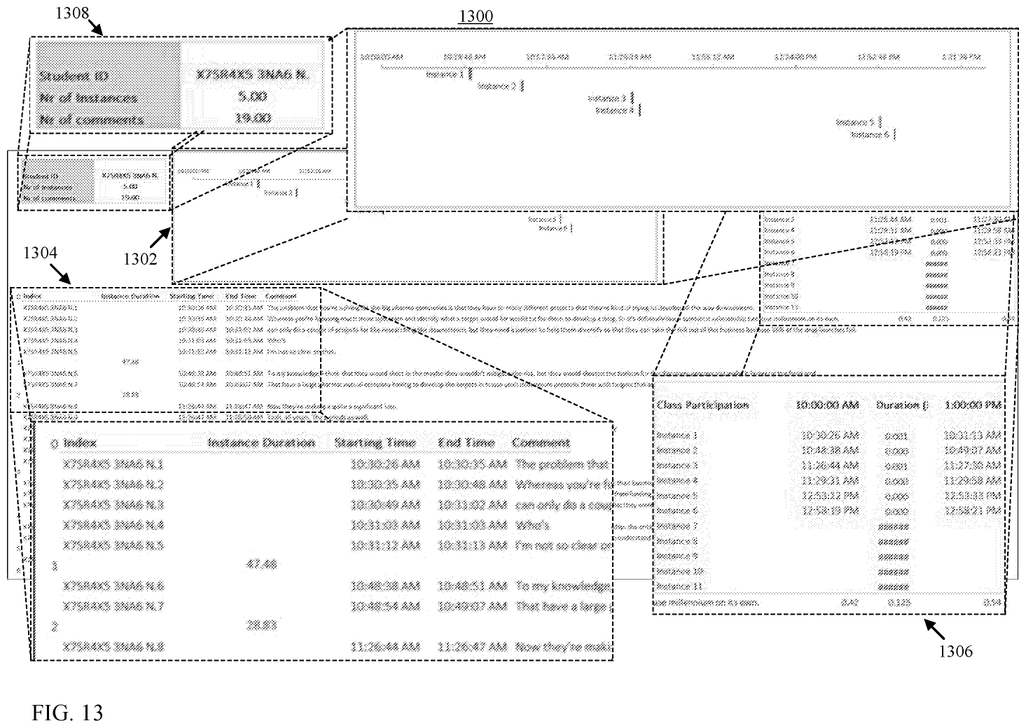

FIG. 13 shows an example 1300 of a report generated using mechanisms described herein illustrating a particular student's participation in a particular class and reporting a transcription of what the student said. In this example, the illustration in report 1300 shows the student name encrypted (e.g., as encoded by the encryption process described above in connection with 418, as part of data manipulation 412). In reports presented to instructors (e.g., using instructor dashboard 444), the names of the students in that instructor's class can be shown in original form (e.g., by unencrypting encryption performed by process 418 to re-identify the student names). Report 1300 shows a graph 1302 of the pattern of participation of the student in that particular class, with instances of speech placed and numbered to show when during the class each instance occurred. Report 1300 also shows a full transcription 1304 of the speech of that student, and a summary 1306 of each instance (e.g., showing starting and ending times, duration, an instance index number, etc.). As shown in FIG. 13, report 1300 can include a user interface element(s) 1308 that can be used to present identifying information about a student (which is encrypted in FIG. 13, but may not be encrypted in some examples), and some relatively general statistics about the student's participation. For example, as shown in FIG. 13, user interface elements 1308 can include statistics associated with the particular class, such as the number of instances and number of comments by the student in the particular class (shown in FIG. 13), total speech time in the class (not shown), average length of instance (not shown), etc. Additionally or alternatively, user interface elements 1308 can include statistics associated with the course (e.g., a series of classes), such as total speech time, average speech time per class, average instances per class, average comments per class, etc. As shown in FIG. 13, in addition to identifying instances of speech, mechanisms described herein can identify portions of a instance (e.g., referred to as “comments” in FIG. 13) or another type of sub-unit of an instance

FIG. 14 shows an example of at least a portion of a report generated using mechanisms described herein illustrating speech time of an instructor and students over the course of a class. In some embodiments, mechanisms described herein can be used to generate a time series illustrating average speech time (e.g., a 1 minute moving average, a 5 minute moving average, etc.) of various participants. For example, as shown in FIG. 14, a 5 minute rolling average speaking time of an instructor can be shown, as well as average speaking time of students and average speaking time of a second highest individual speaker (e.g., other than the instructor). The second highest speaker can be determined based on a speaker that has a second highest total speech time for a class meeting. Such a time series can illustrate whether a discussion is being conducted or a lecture is taking place, and/or whether few participants (e.g., the instructor and a particular student) are monopolizing the discussion.

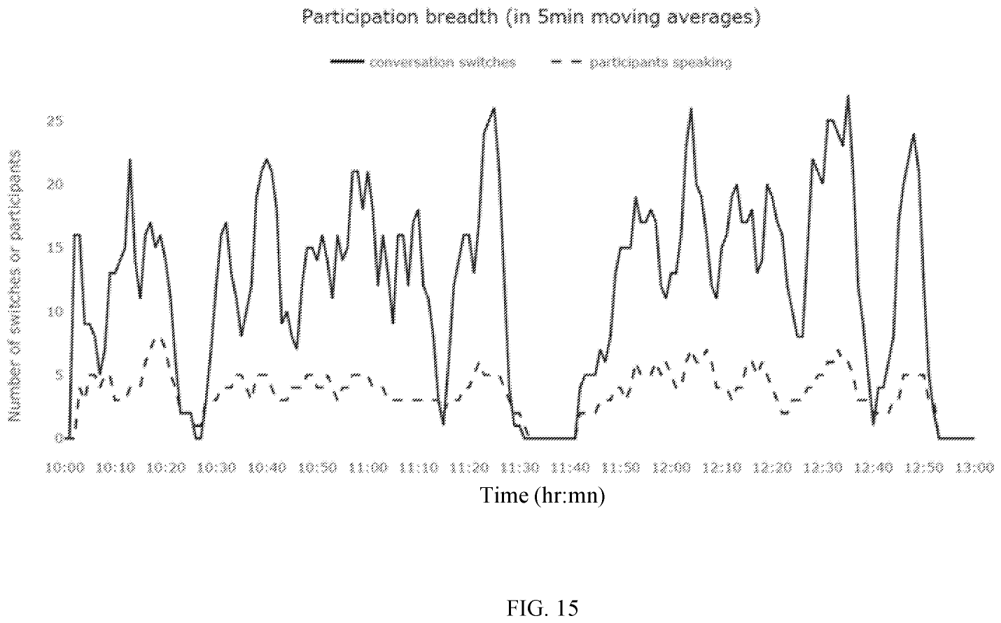

FIG. 15 shows an example of at least a portion of a report generated using mechanisms described herein illustrating conversation switches and number of participants in a discussion over the course of a class. In some embodiments, mechanisms described herein can be used to generate a time series illustrating the number of changes between participants and/or the total number of participants (e.g., on a 1 minute moving average, a 5 minute moving average, etc.) of various participants. For example, as shown in FIG. 15, a 5 minute average of the number of switches between participants can be shown (e.g., each time there is a change between participants), as well as a number of participants that are participating at different points in the class. Such a time series can illustrate whether a discussion is being conducted or a lecture is taking place, and/or whether few participants (e.g., the instructor and a particular student) are monopolizing the discussion and indicative of a breadth of participation is at any point.

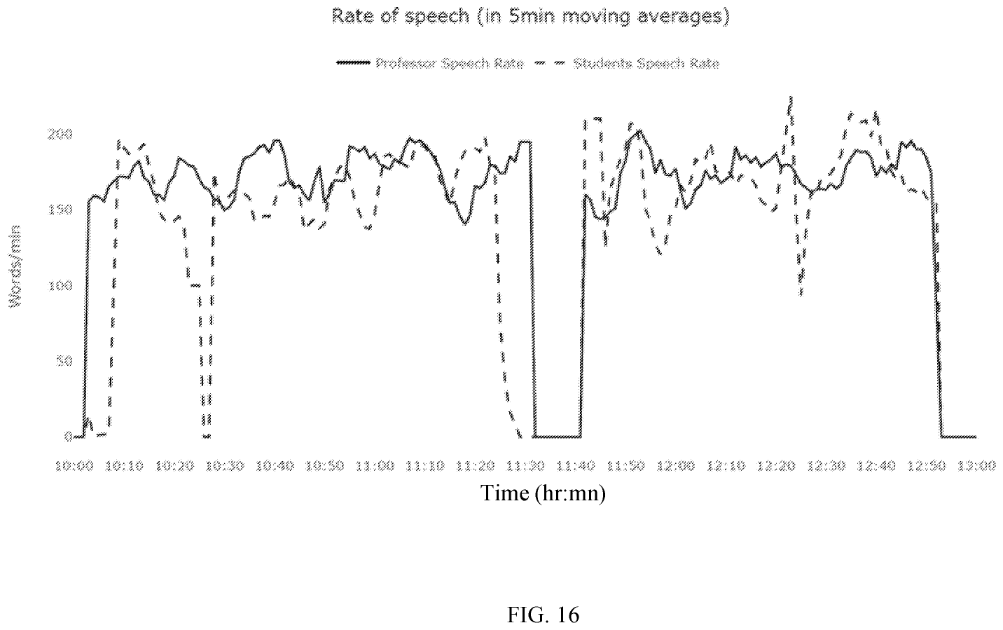

FIG. 16 shows an example of at least a portion of a report generated using mechanisms described herein illustrating a rate of speech of an instructor and students over the course of a class. In some embodiments, mechanisms described herein can be used to generate a time series illustrating a rate of speech by various participants (e.g., a 1 minute moving average, a 5 minute moving average, etc.). For example, as shown in FIG. 16, a 5 minute rolling average of rage of speech can be shown for an instructor and students (e.g., collectively).

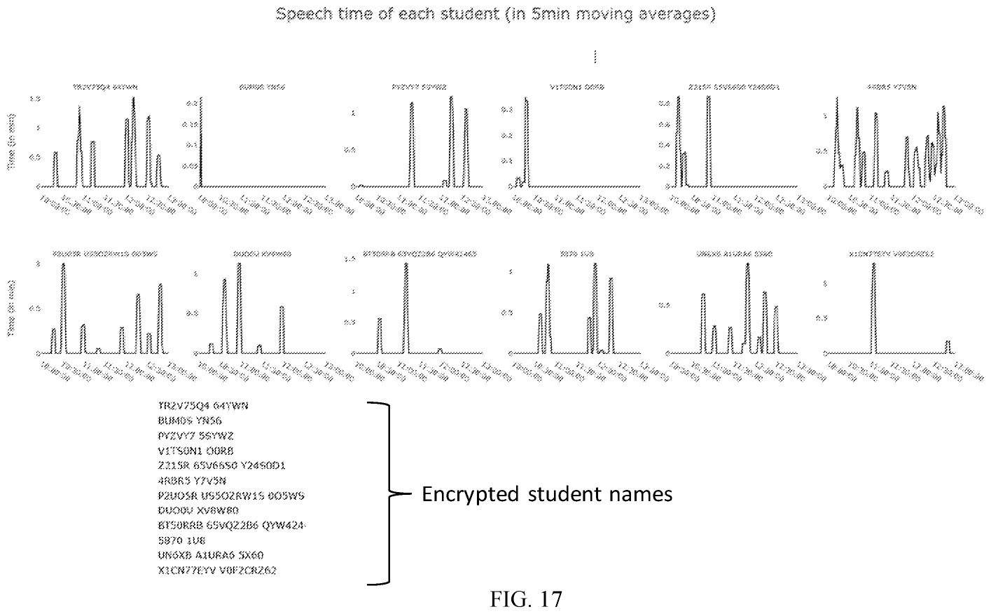

FIG. 17 shows an example of at least a portion of a report generated using mechanisms described herein illustrating speech time by each of various students over the course of a class. In some embodiments, mechanisms described herein can be used to generate time series illustrating speech time of multiple students (e.g., as a 1 minute moving average, as a 5 minute moving average, etc.). For example, such time series can be presented in an instructor dashboard, an administrator dashboard, etc.

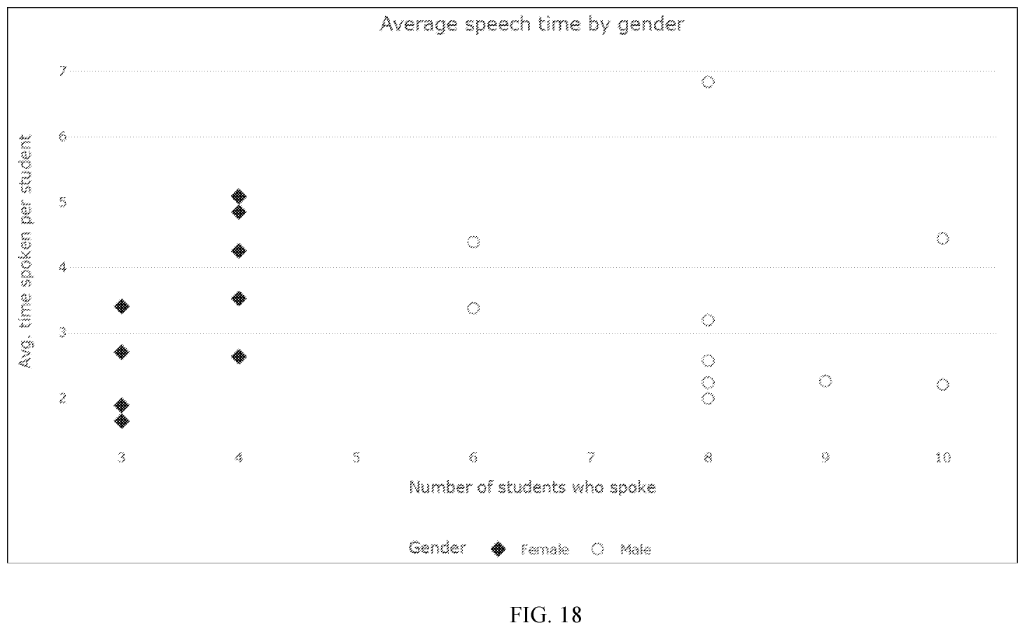

FIG. 18 shows an example of at least a portion of a report generated using mechanisms described herein illustrating a relationship between the average speech time by participants from each gender who spoke in a given class and the number of participants from that gender who spoke in that class. Note that although two gender identifiers are represented, this is merely an example, and additional and/or alternative gender identifiers can be used to generate such a report. For example, if there are one or more non-binary identified participants in a class, an additional data point can be included for non-binary students in each class meeting. Each data point in FIG. 18 represents the average speech time by students of a particular gender that spoke in a class meeting on the y-axis, and the number of students of that gender that spoke in that class meeting on the x-axis. For example, there were two class meetings in which 3 female students spoke for an average of under 2 minutes, two class meetings in which 3 female students spoke for an average of between 2.5 and 3.5 minutes, and one class meeting in which 8 male students spoke for an average of almost 7 minutes. As such, this plot can show components of participation that together yield the total speech time by gender, which was plotted in the earlier illustrations (FIG. 7A, B, C). From this chart, an instructor can identify the factors that underlie a gap in participation (FIG. 7B), such as whether participants from one gender spoke longer or shorter or whether more or fewer participants of that gender spoke. In some embodiments, the total number of students associated with each gender can be included in the report (e.g., the report can indicate that the class included N female students, and M male students).

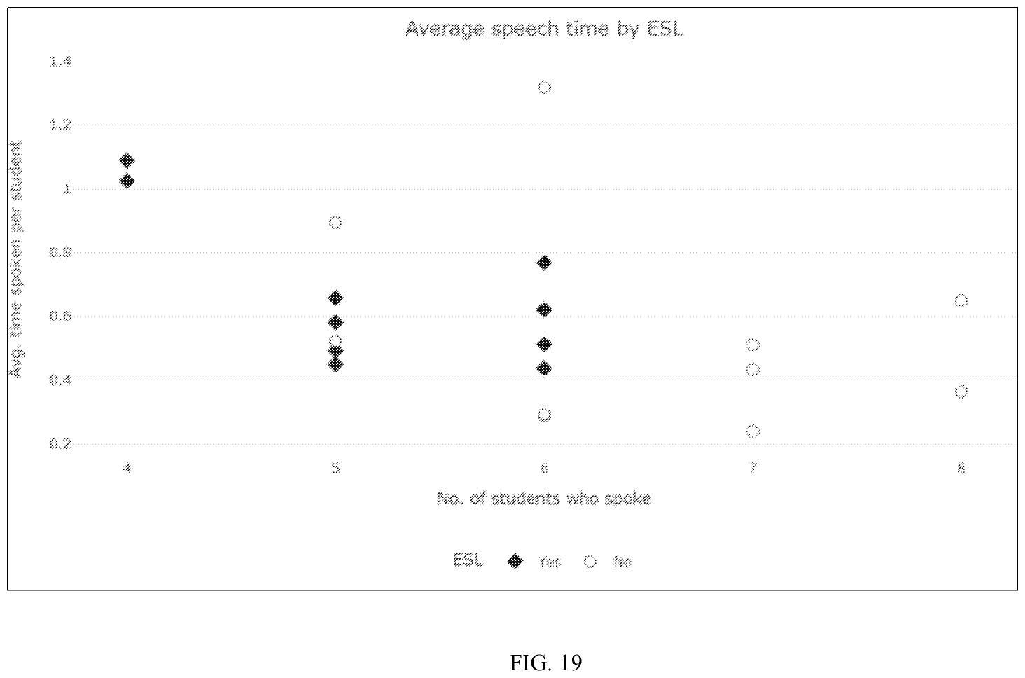

FIG. 19 shows an example of at least a portion of a report generated using mechanisms described herein illustrating average speech time by English as a second language status. Each data point in FIG. 19 represents the average speech time by students of a particular ESL status that spoke in a class meeting on the y-axis, and the number of students of that ESL status that spoke in that class meeting on the x-axis. Note that although gender and ESL status are used as examples in FIGS. 18 and 19, any suitable characteristic(s) of students can be used to generate educational effectiveness indicators that may be indicative of participation by students with different characteristics.

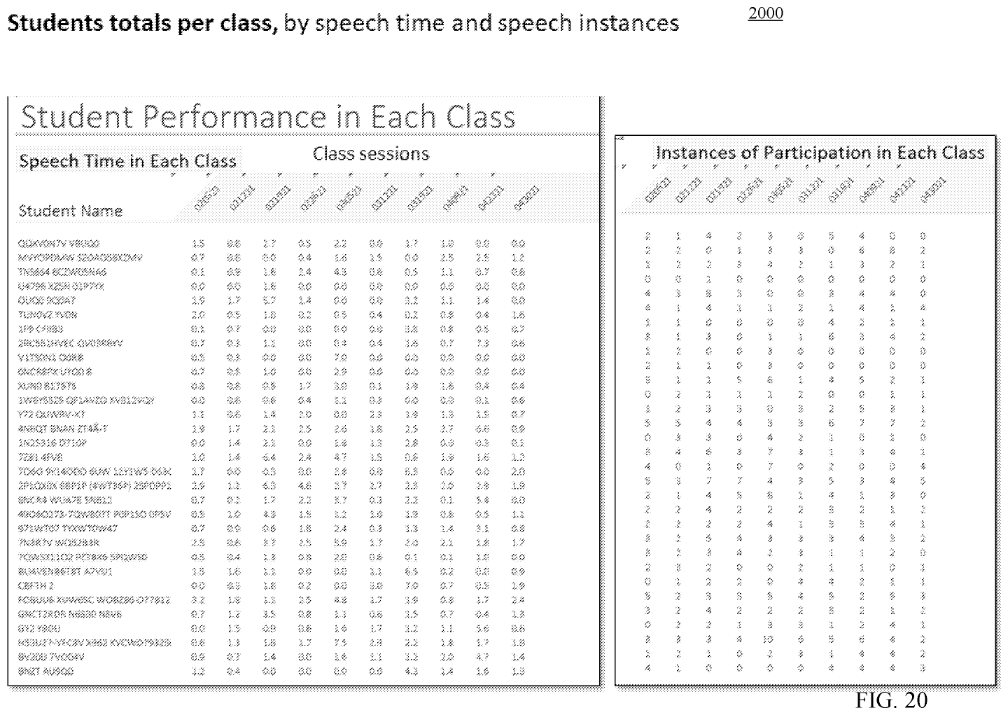

FIG. 20 shows an example 2000 of at least a portion of a report generated using mechanisms described herein illustrating participation by each of various students over the course of a series of classes by total time and instances of speech. In this example, two measures of participation are shown numerically, the total speech time of each student in each class, and the number of speech instances of each student in each class. For each measure of participation, the total is represented numerically (e.g., showing the total participation in time or number of instances across all classes). In some embodiments, a user can provide input that causes a manner in which participation is presented to change. For example, a user can provide input that causes a computing device presenting report 2000 to present participation graphically (e.g., as shown in FIG. 12).

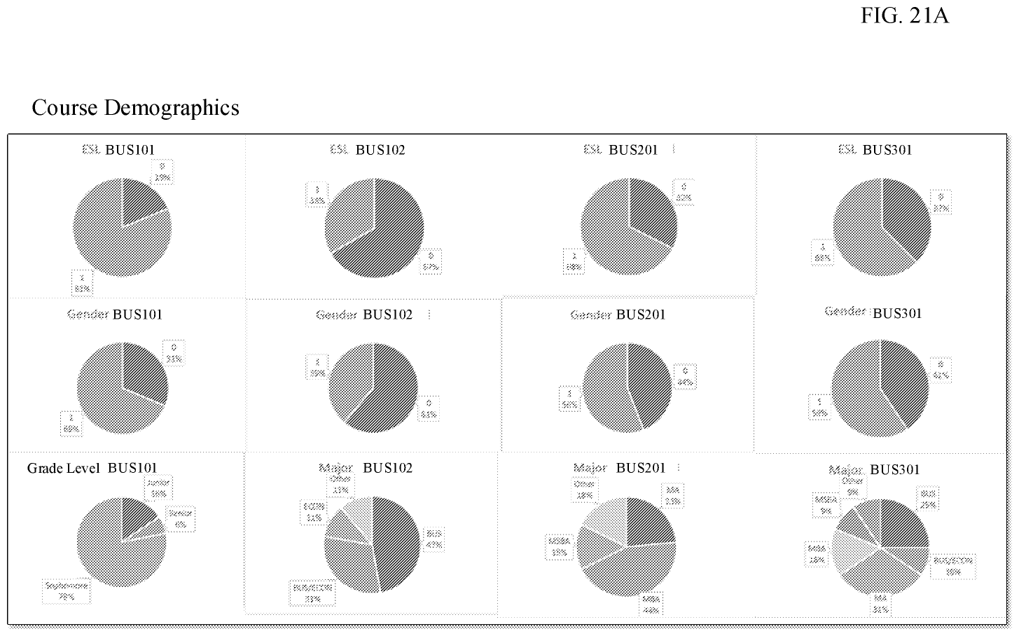

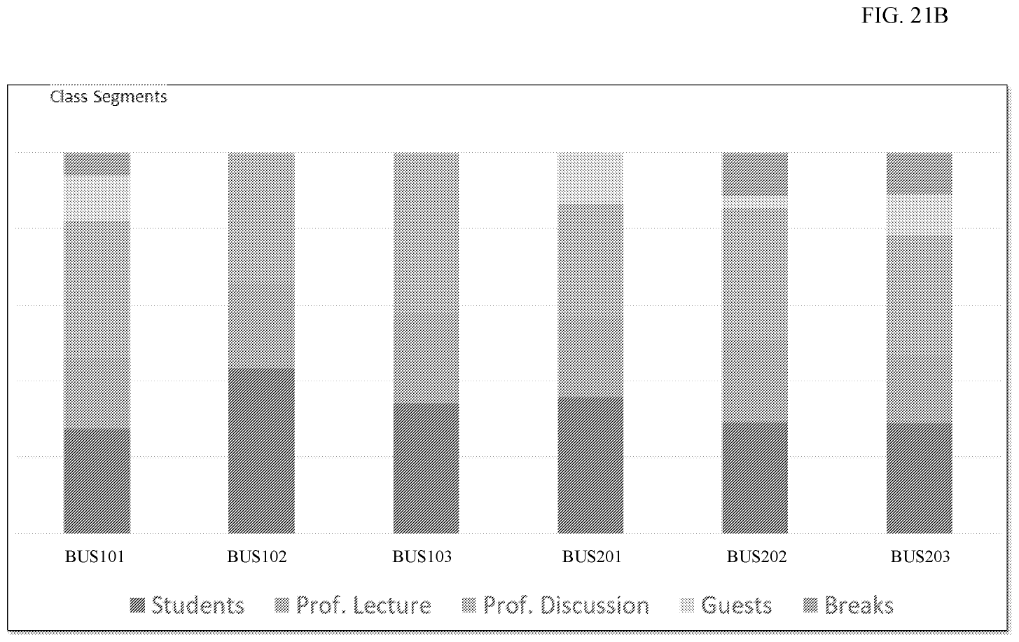

FIG. 21A shows an example of at least a portion of a report generated using mechanisms described herein illustrating participation by various demographic groups in various courses. In this example, participation by different demographic groups in various courses are shown graphically. The share of student participation by each demographic can be represented as a portion of a pie chart (as shown), a bar chart, or any other suitable graphic representation. In FIG. 21A, participation in different courses is presented in the top row based on ESL status for different courses (with 0 representing ESL students, and 1 representing non-ESL students), in the middle row based on gender for different courses (with 0 representing female students, and 1 representing male students), and in the bottom row based on grade level (e.g., undergraduate sophomore, junior, and senior) for the first column, and based on major for the other columns (e.g., economics, business, etc.). All other performance indicators can be compared in the same fashion across courses in similar reports.

FIG. 21B shows an example of at least a portion of a report generated using mechanisms described herein illustrating portions of class time associated with various types of activity in various courses. In this example, class time associated with different activities (e.g., lecture by an instructor, speech time of the instructor during discussion, speech time of students, breaks, and speech by guests, which can be someone that is neither a student nor an instructor). The share of each activity can be represented as a portion of a pie chart, a bar chart (as shown), or any other suitable graphic representation.

Information about participation and activities in different courses (e.g., as shown in FIGS. 21A and 21B) can be presented as part of an instructor dashboard, a school dashboard, a department dashboard, etc. In some embodiments, such a dashboard can include user interface elements that can be used to select classes for which to present data, which demographic categories to use to analyze the data, etc. Presenting information about participation and activities in different course such as the graphics in FIGS. 21A and 21B can aid an instructor and/or administrator in various ways. For example, such information can aid an instructor and/or administrator in evaluating different instructor's pedagogy and calling patterns. As yet another example, such information can aid an administrator in providing feedback to instructors related to participation in a course taught by the instructor.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof. Furthermore, the above described steps of the processes of FIG. 3 can be executed or performed in any order or sequence not limited to the order and sequence shown and described in the figures. Also, some of the above steps of the processes of FIG. 3 can be executed or performed substantially simultaneously where appropriate or in parallel to reduce latency and processing times. In some embodiments, a given step might be skipped or consolidated with others.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for managing education processes in a distributed education environment, the system comprising:
a computer system including at least one processor programmed to:
receive information from a plurality of sources about a live educational process being experienced in a distributed education environment where at least an educator is remotely located from one or more students and the distributed education environment facilitates real-time communication between the educator and the one or more students including at least audio communications;
extract one or more educational effectiveness indicators from at least the audio communications and an operation of the distributed education environment during the live educational process, wherein the one or more educational effectiveness indicators include at least one of a number of audio communications by each of the one or more students during the live educational process, length of audio communications by each of the one or more students during the live educational process, number of audio interactions by each of the one or more students during the live educational process;
access at least one database of demographic information about the one or more students and correlate the demographic information with the one or more students; and
generate a plurality of reports about individual students of the one or more students and groups within the one or more students using the one or more educational effectiveness indicators and the demographic information.

2. The system of claim 1, wherein the at least one processor is further programmed to:
receive information from the plurality of sources about a plurality of live educational processes being experienced in the distributed education environment; and
aggregate one or more educational effectiveness indicators and the plurality of reports across the plurality of live educational processes.

3. The system of claim 1, wherein the at least one processor is further programmed to:
extract the one or more educational effectiveness indicators from a number of video communications that accompany the audio communications.

4. The system of claim 1, wherein the at least one processor is further programmed to:
receive information from the plurality of sources about a plurality of live educational processes across an educational institution being experienced in the distributed education environment; and
aggregate one or more educational effectiveness indicators and the plurality of reports across the plurality of live educational processes.

5. The system of claim 4, wherein the at least one database of demographic information includes a registration database of the educational institution.

6. The system of claim 4, wherein the at least one database of demographic information includes a registration database of part of the educational institution.

7. A method for managing education processes in a distributed education environment, comprising:
receiving information from a plurality of sources about a live educational process being experienced in a distributed education environment where at least an educator is remotely located from one or more students and the distributed education environment facilitates real-time communication between the educator and the one or more students including at least audio communications;
extracting one or more educational effectiveness indicators from at least the audio communications and an operation of the distributed education environment during the live educational process, wherein the one or more educational effectiveness indicators include at least one of a number of audio communications by each of the one or more students during the live educational process, length of audio communications by each of the one or more students during the live educational process, number of audio interactions by each of the one or more students during the live educational process;
accessing at least one database of demographic information about the one or more students and correlate the demographic information with the one or more students; and
generating a plurality of reports about individual students of the one or more students and groups within the one or more students using the one or more educational effectiveness indicators and the demographic information.

8. The method of claim 7, further comprising:
receiving information from the plurality of sources about a plurality of live educational processes being experienced in the distributed education environment; and
aggregating one or more educational effectiveness indicators and the plurality of reports across the plurality of live educational processes.

9. The method of claim 7, further comprising:
extracting the one or more educational effectiveness indicators from a number of video communications that accompany the audio communications.

10. The method of claim 7, further comprising:
receiving information from the plurality of sources about a plurality of live educational processes across an educational institution being experienced in the distributed education environment; and
aggregating one or more educational effectiveness indicators and the plurality of reports across the plurality of live educational processes.

11. The method of claim 10, wherein the at least one database of demographic information includes a registration database of the educational institution.

12. The method of claim 10, wherein the at least one database of demographic information includes a registration database of part of the educational institution.

13. A non-transitory computer readable medium containing computer executable instructions that, when executed by a processor, cause the processor to perform a method for managing education processes in a distributed education environment, the method comprising:
receiving information from a plurality of sources about a live educational process being experienced in a distributed education environment where at least an educator is remotely located from one or more students and the distributed education environment facilitates real-time communication between the educator and the one or more students including at least audio communications;
extracting one or more educational effectiveness indicators from at least the audio communications and an operation of the distributed education environment during the live educational process, wherein the one or more educational effectiveness indicators include at least one of a number of audio communications by each of the one or more students during the live educational process, length of audio communications by each of the one or more students during the live educational process, number of audio interactions by each of the one or more students during the live educational process;
accessing at least one database of demographic information about the one or more students and correlate the demographic information with the one or more students; and
generating a plurality of reports about individual students of the one or more students and groups within the one or more students using the one or more educational effectiveness indicators and the demographic information.

14. The non-transitory computer readable medium of claim 13, the method further comprising:
receiving information from the plurality of sources about a plurality of live educational processes being experienced in the distributed education environment; and
aggregating one or more educational effectiveness indicators and the plurality of reports across the plurality of live educational processes.

15. The non-transitory computer readable medium method of claim 13, the method further comprising:
extracting the one or more educational effectiveness indicators from a number of video communications that accompany the audio communications.

16. The non-transitory computer readable medium of claim 13, the method further comprising:
receiving information from the plurality of sources about a plurality of live educational processes across an educational institution being experienced in the distributed education environment; and
aggregating one or more educational effectiveness indicators and the plurality of reports across the plurality of live educational processes.

17. The non-transitory computer readable medium of claim 16, wherein the at least one database of demographic information includes a registration database of the educational institution.

18. The non-transitory computer readable medium of claim 16, wherein the at least one database of demographic information includes a registration database of part of the educational institution.
